(19) United States
(12) Patent Application Publication
(10) Pub. No.: US 2026/0279333 A1
(43) Pub. Date: Sep. 17, 2026

(54) SYSTEM

(71) Applicant: SoftBank Group Corp., Tokyo (JP)

(72) Inventor: Goki SUGIMURA, Tokyo (JP)

(73) Assignee: SoftBank Group Corp., Tokyo (JP)

(21) Appl. No.: 19/550,350

(22) Filed: Feb. 26, 2026

Related U.S. Application Data
(60) Provisional application No. 63/770,733, filed on Mar. 12, 2025.

(51) Int. Cl. G10L 13/08; G06F 16/34; G06V 10/764; G06V 10/82; G10L 15/26

(52) U.S. Cl. CPC G10L 13/08; G06F 16/345; G06V 10/764; G06V 10/82; G10L 15/26

(57) ABSTRACT

A system includes a processor, the processor is configured to: collect video data and audio data from camera-equipped smart glasses worn by bystanders located near a site of an accident, incident, or disaster; analyze the collected video data and audio data to identify a situation at the site; generate, based on a result of the analysis, an announcement summarizing an outline of the situation at the site; and provide the generated announcement to personnel heading toward the site.

### CROSS-REFERENCE TO RELATED APPLICATION

This application claims the benefit of U.S. Provisional Application No. 63/770,733 filed on Mar. 12, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for obtaining situational awareness at scenes of accidents, incidents, or disasters rely primarily on reports from victims, witnesses, or first responders who directly contact an emergency center. In many cases, such information is delayed, fragmentary, subjective, or incomplete, which makes it difficult for emergency personnel to accurately understand the scale, location, danger level, and required countermeasures before arriving at the scene. Furthermore, existing video monitoring systems, such as fixed surveillance cameras, cannot adequately capture the situation from the viewpoint of bystanders who are actually near the site and may not cover the precise location where an event occurs. Still further, there is often no integrated mechanism for automatically collecting multimodal data (video and audio) from nearby devices, analyzing such data in real time, and providing summarized announcements to personnel heading toward the site in a secure and privacy-conscious manner. As a result, the deployment of appropriate resources may be delayed, the initial response may be inadequate, and overall damage and risk to human life may increase. Accordingly, there is a need for a system that can rapidly and accurately collect video and audio data from smart glasses worn by bystanders near a site of an accident, incident, or disaster, automatically analyze the data to identify the situation at the site, generate an announcement summarizing the situation, and provide the announcement in real time to personnel heading toward the site.

### SUMMARY

In order to solve at least the above-described problems, an aspect of the present invention provides a system comprising a processor, wherein the processor is configured to collect video data and audio data from camera-equipped smart glasses worn by bystanders located near a site of an accident, incident, or disaster, analyze the collected video data and audio data to identify a situation at the site, generate, based on a result of the analysis, an announcement summarizing an outline of the situation at the site, and provide the generated announcement to personnel heading toward the site. In one embodiment, the processor is further configured to identify, based on position information of the smart glasses, one or more devices located near the site, transmit a notification to the identified devices requesting permission to collect video data and audio data, collect, in real time, the video data and the audio data from devices from which permission has been obtained, and transmit the collected video data and audio data to a central server using an encrypted communication protocol. In another embodiment, the processor is configured to analyze the video data using an object recognition algorithm based on machine learning to identify persons, vehicles, and buildings present at the site, and to analyze the audio data using natural language processing to extract important information from conversations and sounds at the site. The processor is further configured to generate, based on the analysis results, an outline announcement including at least a location of the site, a scale of the situation, a number of persons involved, a degree of danger, and required countermeasures, and to convert the outline announcement into an audio format using speech synthesis. By these means, the system can rapidly and accurately obtain situational awareness at the scene, and can provide concise, actionable information to personnel heading toward the site, thereby supporting timely and appropriate emergency response and contributing to reduction of damage.

The term “system” refers to an arrangement of hardware and software components including at least one processor configured to execute the functions recited in the claims.

The term “processor” refers to one or more hardware processing units, such as a central processing unit (CPU), a graphics processing unit (GPU), a digital signal processor (DSP), or a combination thereof, capable of executing instructions to perform the operations described in the claims.

The term “camera-equipped smart glasses” refers to wearable eyeglass-type devices that include at least a camera, a processor or controller, and a communication interface, and that are configured to capture video data and optionally audio data from a user's viewpoint.

The term “bystanders” refers to people who are present near a site of an accident, incident, or disaster, and who are not primarily responsible for emergency response operations at that site.

The term “site” refers to a geographic location at which an accident, incident, or disaster has occurred or is occurring.

The term “accident, incident, or disaster” refers to an emergency event including, but not limited to, traffic accidents, criminal incidents, fires, explosions, natural disasters, industrial accidents, and other events requiring emergency response.

The term “video data” refers to image information captured over time by the camera-equipped smart glasses, including still frames, sequences of frames, or compressed video streams.

The term “audio data” refers to sound information captured by a microphone of the camera-equipped smart glasses or a related device, including speech, environmental sounds, and other acoustic signals.

The term “situation at the site” refers to a state of conditions at the site, including at least objects present, persons involved, the scale of the event, hazards, and other factors relevant to emergency response.

The term “announcement” refers to a message generated by the system that summarizes information about the situation at the site and is intended to be provided to personnel heading toward the site.

The term “outline of the situation” refers to a summarized description of key aspects of the situation at the site, including at least a location, a scale, a number of persons involved, a degree of danger, and required countermeasures.

The term “personnel heading toward the site” refers to individuals or teams, such as first responders, emergency services, or other authorized parties, who are moving or are about to move toward the site to perform response actions.

The term “position information” refers to information indicating a geographic position of the camera-equipped smart glasses or other devices, such as coordinates obtained from a global navigation satellite system (GNSS) or other location determination techniques.

The term “devices located near the site” refers to camera-equipped smart glasses or other communication-capable devices whose position information indicates that they are within a predetermined distance from the site.

The term “notification” refers to a message transmitted from the system to a device to request permission, convey information, or prompt an action, such as a request to start collecting video data and audio data.

The term “permission to collect” refers to consent, authorization, or approval obtained from a device or its user that allows the system to collect and use video data and audio data from that device.

The term “real time” refers to processing and communication performed with a delay that is sufficiently small such that the collected data and generated announcements substantially reflect the current situation at the site.

The term “encrypted communication protocol” refers to a communication protocol that applies cryptographic techniques to protect confidentiality and integrity of transmitted data, such as Transport Layer Security (TLS) or an equivalent protocol.

The term “central server” refers to one or more server devices, which may be implemented as a cloud system, data center, or other centralized computing infrastructure, configured to receive, store, and process data from multiple devices.

The term “object recognition algorithm based on machine learning” refers to a computational method, such as a convolutional neural network (CNN) or a comparable model, trained to detect and classify objects (including persons, vehicles, and buildings) within video data.

The term “persons, vehicles, and buildings present at the site” refers to human individuals, transport means such as cars, trucks, or buses, and constructed structures such as houses, offices, or other buildings that exist within the field of view of the captured video at or near the site.

The term “natural language processing” refers to computational techniques for analyzing, interpreting, or extracting information from human language, including speech transcripts, to identify important information such as keywords, entities, or urgency.

The term “conversations and sounds at the site” refers to spoken utterances, shouts, commands, and other human-generated or environmental audio signals captured in the vicinity of the site.

The term “degree of danger” refers to an assessment or classification of the level of risk or hazard at the site, including, for example, low, medium, or high risk, based on analysis of the collected data.

The term “required countermeasures” refers to recommended actions or responses to be taken at or near the site, such as dispatching specific emergency units, performing evacuations, or applying particular rescue operations.

The term “speech synthesis” refers to a process or technology, including text-to-speech (TTS) techniques, that converts text data into audio signals representing human-like speech.

The term “audio format” refers to a digital representation of audio information, such as a waveform or compressed audio file, that can be played back by audio reproduction devices.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

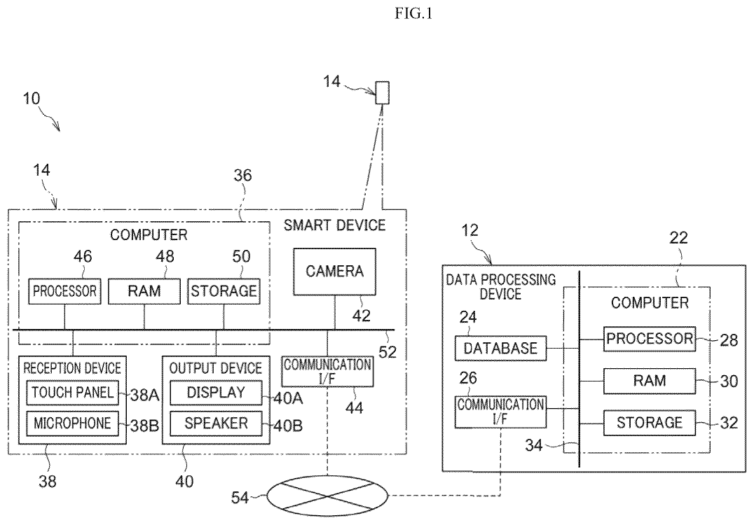

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

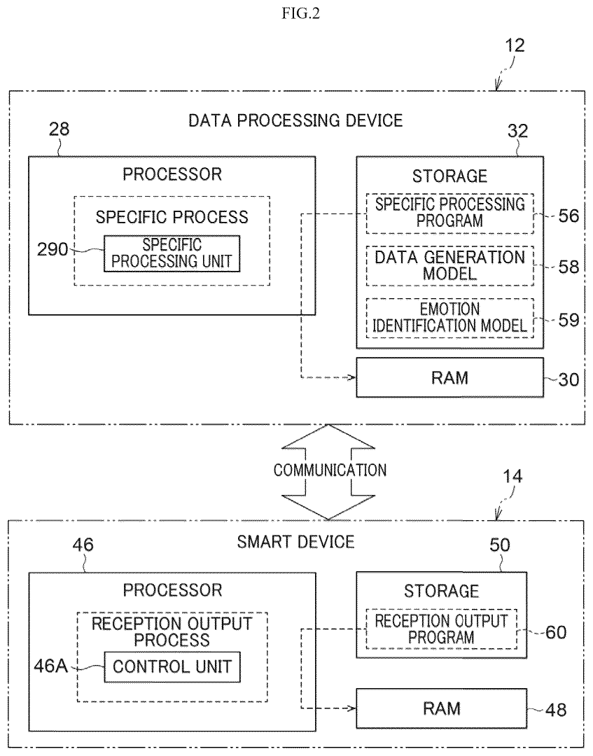

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional incident management systems, computer processing for situational awareness at accident, incident, or disaster scenes suffers from several technical limitations. First, collection of multimodal data such as image information, audio information, position information, and motion information is often performed in a fragmented or uncoordinated manner, such that computing devices cannot reliably correlate these heterogeneous data streams in time. As a result, server-side analysis routines cannot construct a coherent, machine-usable representation of the situation, leading to incomplete or inconsistent inputs for downstream processing.

Second, even when machine learning engines for object detection and speech recognition are employed, the outputs are typically low-level and unstructured. Conventional servers must execute complex, manual rule-based logic to combine detected objects, recognized phrases, and location traces. This processing burdens the computing resources, introduces latency, and often fails to generalize across diverse scenarios. The computer system is therefore unable to efficiently transform raw sensor data into a normalized, structured state representation that can be reused and updated over time.

Third, traditional computer systems do not effectively exploit generative artificial intelligence models for incident summarization. Generative models, when used at all, are often invoked with ad hoc or static prompts that do not accurately encode the machine-readable analysis results. Consequently, the generated summaries may omit critical attributes such as the number and positions of moving objects, the presence and location of hazardous factors, or specific traffic obstruction states. This mismatch between structured data and free-form prompts reduces the reliability and utility of generative models from a computing standpoint.

Fourth, existing systems provide limited support for incremental updates. When the situation at a site changes, the server commonly regenerates entire reports from scratch or relies on human operators to interpret new data. This approach does not take advantage of the computer's ability to automatically re-prompt a generative model with updated structured information at defined update units, and thus cannot efficiently maintain up-to-date, machine-generated, role-specific summaries for different terminal devices. This leads to high computational overhead, non-deterministic response patterns, and delayed propagation of critical changes.

Accordingly, there is a need for an improved computer-implemented system and server-side processing architecture that: (i) systematically acquires and time-aligns multimodal data from user-worn devices; (ii) converts the data into structured information by integrated image analysis, audio analysis, and sensor fusion; (iii) programmatically constructs prompt sentences that encode such structured information as machine-readable instructions to a generative AI model; and (iv) iteratively regenerates and distributes updated textual and audio summaries tailored to different classes of recipients. By addressing these issues at the level of data representation, model invocation, and update handling, the invention aims to improve the technical functioning of the computing system itself, including reduced latency, improved consistency of generated outputs, and more efficient utilization of processing and communication resources.

The specific processing by the specific processing unit 290 of the data processing device 12 in Example 1 is realized by the following means.

The present invention provides a server comprising a processor and a memory storing instructions that, when executed by the processor, cause the processor to acquire, from one or more information processing devices worn by users located near an incident site, image information, audio information, position information, and motion information, and to associate the acquired information with time information to generate time-correlated information groups; to encrypt and transmit the information groups via a secure communication path; to execute, on the server side, feature extraction processing and object classification processing on the image information to detect objects including persons, moving bodies, structures, and hazardous factors, and to execute speech recognition processing and language analysis processing on the audio information to extract urgency-related phrases and acoustic events; to integrate analysis results with the position information and the motion information to generate structured information representing a current situation at the site; to generate, based on the structured information, an input text including a prompt sentence that instructs a generative information processing model to perform situation summarization, danger degree estimation, and response policy generation, and to input the input text and the structured information to the generative information processing model to obtain explanation text information including a type, scale, obstruction state, and expected damage content of the site; to derive, from the explanation text information, first explanation text information for stationary stakeholders and second explanation text information for stakeholders in transit, and to convert the second explanation text information into audio information by speech synthesis processing; and to transmit the first explanation text information and the audio information to one or more communication terminal devices for presentation in association with map display information and travel route information, and further to repeatedly generate, for each update unit, updated structured information and updated explanation text information, to re-input updated prompt sentences and structured information to the generative information processing model so as to generate updated summary information reflecting changes in the situation at the site, and to automatically transmit notification information including the updated summary information to the communication terminal devices. This enables the computer system to automatically construct and maintain a machine-optimized, time-evolving representation of an incident scene, to invoke a generative AI model with precisely structured prompt sentences derived from analyzed sensor data, and to deliver consistently formatted, role-specific textual and audio summaries with reduced processing overhead and improved responsiveness compared to conventional systems.

The term “system” refers to an overall arrangement of one or more hardware components and software components that cooperate to perform the processing described in the claims.

The term “processor” refers to a hardware information processing unit, such as a central processing unit or a programmable processing circuit, that executes instructions stored in a memory.

The term “memory” refers to a hardware storage device, such as a volatile or non-volatile storage medium, that stores instructions and data for execution by the processor.

The term “information processing server” refers to a computing apparatus including at least one processor and at least one memory, configured to receive data from remote devices, perform analysis, interact with models, and output results according to the claims.

The term “information processing device” refers to a computing apparatus worn or carried by a user, the computing apparatus including at least one sensor and at least one communication interface to transmit acquired information to the server.

The term “communication terminal device” refers to a computing apparatus used by a stakeholder or responder, configured to receive, display, and optionally play audio for information transmitted from the server.

The term “user” refers to a human individual who wears or operates an information processing device and who may be a bystander, witness, or responder near a scene.

The term “scene of an accident, incident, or disaster” refers to a physical location at which a traffic accident, criminal event, natural disaster, fire, or other emergency event is occurring or has occurred.

The term “image information” refers to digital data representing visual content acquired by an image sensor, including still images and video frames.

The term “audio information” refers to digital data representing sound acquired by a microphone, including speech, environmental noise, and acoustic events.

The term “position information” refers to digital data indicating a geographic location of a device, such as coordinates or related location indicators obtained from a positioning system.

The term “motion information” refers to digital data indicating movement or orientation of a device or user, derived from one or more motion sensors such as accelerometers or gyroscopes.

The term “time information” refers to digital data indicating a point in time or time interval, such as a timestamp or time range associated with captured data.

The term “information group” refers to a set of related image information, audio information, position information, and motion information that has been associated with time information.

The term “secure communication path” refers to a communication channel between devices that provides confidentiality and integrity of transmitted data using an encryption protocol.

The term “encrypt” refers to performing a cryptographic operation on data so that the data is transformed into a format that is unintelligible without corresponding decryption information.

The term “feature extraction processing” refers to computational operations that derive characteristic values or descriptors from image information for use in object detection or classification.

The term “object classification processing” refers to computational operations that assign category labels to detected regions or elements in image information.

The term “object” refers to a detectable entity in image information, including but not limited to persons, moving bodies, structures, and hazardous factors.

The term “person” refers to a human being detected in image information.

The term “moving body” refers to a physical object capable of motion, such as a vehicle or other transport means, detected in image information.

The term “structure” refers to a constructed physical object such as a building, road, or other built environment element detectable in image information.

The term “hazardous factor” refers to a condition or object that presents potential danger, including but not limited to fire, smoke, explosion, or obstruction.

The term “speech recognition processing” refers to computational operations that convert audio information into digital text representing spoken words or phrases.

The term “language analysis processing” refers to computational operations that analyze textual content to identify linguistic features such as keywords, entities, sentiment, or intent. The term “urgency-related phrase” refers to a word or phrase in recognized text that indicates emergency, danger, distress, or need for immediate action.

The term “acoustic event” refers to a sound pattern detectable in audio information, such as a siren, explosion, or alarm, that may be indicative of an emergency condition.

The term “structured information” refers to data organized in a predefined schema or format, such as a set of fields or a structured document, representing a situation at a site in a machine-usable form.

The term “generative information processing model” refers to a trained machine learning model configured to generate text or other data outputs in response to input data and instructions.

The term “prompt sentence” refers to text included in an input to a generative information processing model that instructs the model regarding tasks to perform, content to generate, or format of output.

The term “input text” refers to a textual data structure provided to a generative information processing model, the textual data structure including a prompt sentence and optionally additional content.

The term “explanation text information” refers to text generated by a generative information processing model that describes a situation at a site, including type, scale, obstruction state, and expected damage content.

The term “first explanation text information” refers to explanation text information formatted or adapted for presentation to stationary stakeholders such as dispatch center operators.

The term “second explanation text information” refers to explanation text information formatted or adapted for presentation to stakeholders in transit, such as responders traveling to the site.

The term “speech synthesis processing” refers to computational operations that convert text into audio information representing spoken language.

The term “map display information” refers to digital data representing a geographical map, including location markers and optional annotations such as blocked routes or incident sites.

The term “travel route information” refers to digital data indicating one or more paths or routes usable by a responder or stakeholder to travel to or around a site.

The term “update unit” refers to a time-based or event-based interval at which structured information and explanation text information are regenerated to reflect changes in a situation.

The term “updated structured information” refers to structured information that has been regenerated or modified based on data collected during a subsequent update unit.

The term “updated summary information” refers to explanation text information or derived summary that has been regenerated to reflect changes represented in updated structured information.

The term “notification information” refers to data transmitted from the server to a communication terminal device, the data including at least part of updated summary information and optionally additional metadata.

In an embodiment, the system includes a server, one or more terminals, and one or more users located near an accident, incident, or disaster scene. The server includes at least one processor, at least one memory, and at least one communication interface. The terminal includes at least one processor, at least one memory, at least one image sensor, at least one audio sensor, at least one motion sensor, at least one position sensor, and a wireless communication interface. The user wears the terminal in the form of smart glasses or another wearable information processing device.

The terminal acquires multimodal data in a hardware-constrained environment. The terminal uses a camera module, controlled by an operating system camera API such as an Android Camera2 API or an equivalent imaging framework, to capture image information as successive video frames. The terminal uses a microphone module, controlled by an audio API such as an AudioRecord API or an equivalent audio capture framework, to capture audio information as digital sound samples. The terminal uses a location module, which may be a satellite positioning receiver, controlled by a location API such as a Location API, to acquire position information as geographic coordinates and associated accuracy and time values. The terminal uses motion sensors such as an accelerometer and a gyroscope, controlled by a sensor API such as a Sensor API, to acquire motion information as multi-axis acceleration vectors and angular velocity vectors.

The terminal associates these heterogeneous sensor outputs with time information at the terminal side. The terminal uses a system clock or high-resolution timer to obtain a timestamp for each captured video frame, audio buffer, position sample, and motion sample. The terminal stores the data in a memory using a data structure in which an image frame identifier is mapped to a set of attributes including image pixel data, capture timestamp, nearest-in-time audio segment identifier, position coordinates, and motion vectors. This local correlation reduces the amount of re-alignment computation required at the server, thereby reducing processing latency and avoiding temporal drift between modalities.

The terminal performs data reduction and encryption prior to transmission. The terminal compresses the image information using a video codec such as a block-based transform codec (for example, H.264 or H.265) executed through a media codec API that uses dedicated hardware accelerators where available. The terminal compresses the audio information using a waveform codec such as a pulse-code modulation format or a perceptual codec such as an advanced audio coding format. The terminal aggregates position information and motion information into compact arrays or key-value pairs representing time-stamped samples. The terminal then uses a security library, such as an implementation of a transport layer security protocol, to establish a secure communication channel to the server and to encrypt packets containing the compressed image information, audio information, position information, and motion information. This pre-processing at the terminal reduces the amount of raw data transmitted over the network, reducing communication load and enabling real-time operation under bandwidth constraints.

The server receives the encrypted data via the communication interface and stores the data in a structured manner. The server uses a network stack, such as a hypertext transfer protocol over an encrypted transport layer, terminated by a web server framework, to authenticate the terminal, decrypt incoming packets, and parse payloads. The server writes video streams to a storage device such as a mass storage array or distributed object storage, and writes audio streams to corresponding audio objects. The server writes position and motion samples, together with references to corresponding video and audio objects, into a database structure such as a relational database table or document store. The database schema defines entities such as incident, device, segment, object_detection, audio_event, and summary, with foreign keys that allow the server to correlate data by incident identifier, device identifier, and time interval.

The server executes image analysis using a neural network-based object detection algorithm. The server loads a convolutional neural network into memory, which may be instantiated in a framework such as a tensor-based computation library. The convolutional neural network includes an input layer that receives pixel values, multiple convolutional layers with learned filters, non-linear activation layers such as rectified linear units, pooling layers, and fully connected layers that output bounding box coordinates and class probabilities. The server optionally uses a one-stage detector architecture such as a grid-based detector, or a two-stage detector architecture such as a region proposal network followed by a classifier. The server normalizes input frames, performs inference on a graphics processing unit, and obtains feature maps and detection tensors as intermediate results. The server then applies non-maximum suppression to remove overlapping detections and produces, for each frame, a set of objects labeled as person, moving body, structure, or hazardous factor with associated scores.

The server executes motion-aware object tracking by combining detections across frames.

The server uses an algorithm such as a metric learning-based tracker or a Kalman filter-based tracker. The server computes motion vectors by comparing detected bounding boxes between adjacent frames and by integrating motion information derived from the terminal's motion sensors. The server assigns persistent identifiers to objects and calculates trajectories, speeds, and spatial relationships such as following distance and collision proximity. This combination of image-based tracking with sensor-based motion information allows the server to achieve higher robustness in low frame-rate or partially occluded scenes, thereby improving detection stability as a technical effect.

The server executes audio analysis using a neural network-based speech recognition model. The server loads an acoustic model and a language model in memory. The acoustic model may be an encoder-decoder architecture or a recurrent neural network with long short-term memory units, trained to map sequences of acoustic features, such as mel-frequency cepstral coefficients or log-mel spectrograms, to phonetic or character sequences. The language model may be a probabilistic model or a transformer-based sequence model that estimates probabilities of token sequences. The server splits audio information into overlapping windows, extracts spectral features using a fast Fourier transform and filterbank operations, and feeds the features into the acoustic model. The server uses beam search with the language model to decode text sequences and obtain time-aligned transcriptions.

The server further executes natural language analysis on the recognized text. The server loads a transformer-based text classifier that includes an embedding layer, multiple self-attention layers, and a classification head. The server inputs tokenized transcriptions and obtains contextualized embeddings for each token. The server classifies tokens or spans into categories such as urgency-related phrase, neutral phrase, or noise. The classifier outputs scores indicating likelihood that a phrase corresponds to conditions such as fire, explosion, trapped person, blocked route, or multiple casualties. The server stores extracted phrases with timestamps, spatial references where possible, and severity scores as discrete records in the database.

The server fuses the results of image analysis, motion analysis, and audio analysis into structured information. The server defines a structured incident representation as a machine-readable object that includes fields such as incident_type, object_list, lane_blockage_state, hazard_presence, estimated_casualties, confidence_values, and spatial_extent. The server populates the object_list with entries for each tracked object, including type, position in a coordinate system, velocity, and relation to other objects. The server assigns lane_blockage_state based on object positions relative to lane geometries derived from map data. The server assigns hazard presence based on detection of fire, smoke, or other hazardous factors in image information and confirmation by urgency-related phrases in audio information. The server computes estimated_casualties by combining the number of detected persons, severity of urgency-related phrases, and proximity to hazardous regions. The server uses this structured information to generate prompt sentences for a generative AI model. The server constructs an input text that includes (i) a description portion encoding key fields of the structured information using controlled vocabulary and (ii) a prompt sentence portion that instructs the generative AI model regarding tasks and output format. The server avoids simply passing raw video or free-form text; instead, the server generates a deterministic textual template that captures machine-derived features as explicit statements. This non-conventional use of structured representations in prompt construction reduces ambiguity in the generative model's behavior and leads to more consistent outputs, which improves the predictability of the computer system as a whole.

In one example, the server generates the following prompt sentence for scene analysis:

“The server provides the following structured data for an incident scene:
Location: latitude 35.6804, longitude 139.7690, major intersection
Time window: 12:01:00 to 12:01:05
Video analysis: 3 passenger vehicles and 1 larger vehicle detected; one passenger vehicle and the larger vehicle show fire and thick smoke; at least 5 persons detected near the vehicles; two eastbound lanes fully blocked and westbound lanes partially blocked.
Audio analysis: transcript contains ‘There is a fire, someone is trapped inside the car!’ with highest urgency level 5.

As a generative AI model for emergency analysis, summarize the current situation in plain English for dispatchers. Clearly state: type of incident, number of vehicles, presence and location of fire, likely number of injured or trapped persons, and which lanes are blocked. Limit the summary to 4 to 6 short sentences.”

In another example, the server generates a refinement prompt sentence for a condensed announcement:

“The server provides this base summary:

‘There is a multi-vehicle collision involving three cars and one larger vehicle at a major intersection. One car and the larger vehicle are on fire with heavy smoke visible. At least five people are present at the scene, and at least one person appears trapped inside a vehicle. Two eastbound lanes are fully blocked and westbound traffic is partially obstructed. Immediate fire suppression and rescue operations are required.’

Rewrite this summary in very concise form suitable to be played as a voice announcement inside an emergency vehicle. Use 3 to 4 short sentences and avoid technical terms.”

The server inputs the constructed input text and the structured information, when required, to the generative AI model. The generative AI model may be a transformer-based sequence-to-sequence model with an encoder that consumes the input text tokens and a decoder that generates output text tokens. The model includes multiple self-attention layers with learned parameters (weights and biases), a positional encoding mechanism, and a final linear layer mapping to vocabulary logits. The model is trained beforehand on corpora that include general language data and specialized data for emergency reporting. Training may use a loss function such as a cross-entropy loss and an optimization algorithm such as a stochastic gradient-based optimizer. During inference, the server operates the model in a deterministic or constrained decoding mode, such as beam search with penalties for length or repetition, to obtain explanation text information that adheres to the prompt instructions.

The server does not simply delegate decision-making to an opaque model; rather, the server constrains, structures, and post-processes the model outputs. The server parses the explanation text information, checks for required elements such as incident type, number of vehicles, hazards, and blocked lanes, and in some embodiments, rejects or regenerates outputs that do not satisfy predefined criteria. This rule-based post-processing, in combination with the structured prompts, implements a non-standard orchestration pattern where the generative model acts as a controlled text generator embedded in a larger deterministic pipeline.

The server generates role-specific explanation text information. The server derives first explanation text information by preserving detailed fields and technical terms suitable for control room operators. The server derives second explanation text information by shortening sentence length, removing extraneous details, and organizing information in an order optimized for in-vehicle consumption, such as hazard first, location second, and recommended action third. The server stores both versions in the database.

The server converts the second explanation text information into audio information using a speech synthesis engine. The speech synthesis engine may be a neural text-to-speech model including an encoder that converts text into phoneme or character embeddings, a duration or prosody predictor, and a waveform generator such as an autoregressive or non-autoregressive neural vocoder. The server provides synthesis parameters such as language, speaking rate, and voice type. The server receives audio samples and stores them as audio files or streams in storage associated with incident records.

The server distributes explanation text information and audio information to communication terminal devices. The server uses a notification subsystem to send alerts containing metadata such as incident identifier, location, urgency level, and references to content. The server exposes an application programming interface that allows terminals to request full summaries. The server responds with structured payloads including map display information, travel route information derived from external map services, and links to explanation text information and audio information.

The terminal, when used as a communication terminal device by a responder, renders the received information. The terminal uses a map rendering engine to display the position of the incident, blocked lanes, and recommended approach routes. The terminal displays the first or second explanation text information in a text area and plays the audio information through a speaker using an audio playback subsystem. By integrating map display information and travel route information with incident summaries, the terminal provides context that allows a responder to adapt driving behavior, which is a direct control of physical movement in the real world.

The user, when acting as a responder, interacts with the terminal to confirm receipt, request additional views such as live video, or update status. These interactions cause the terminal to send additional structured data back to the server, including responder position, estimated arrival time, and on-site observations. The server incorporates such responder-provided data as additional inputs to the structured information and generates updated prompt sentences, which then result in updated summaries.

The server supports iterative updates in units of time or events. The server defines an update unit as a specified time interval or a detected change threshold, such as a newly detected hazardous factor or change in lane blockage. At each update unit, the server recomputes structured information using new incoming data and prior context, and regenerates explanation text information by re-prompting the generative AI model. By using incremental updates instead of recomputing from scratch, the server reduces computational load and response time while maintaining consistency of reports over time.

The technical effect of this architecture is that the server improves computer performance for incident analysis. Because the server uses structured information as an intermediate representation, it reduces the combinatorial explosion of ad hoc rule-based logic and enables modular reuse of analysis results. Because the server generates prompt sentences that encode this structured information with explicit instructions, the generative AI model produces summaries that are consistently aligned with machine-detected facts, reducing errors and ambiguities seen in naive use of generative models. Because the server performs sensor fusion of image, audio, position, and motion information at a low level, it improves detection accuracy for hazardous factors and blocked lanes compared to systems that rely solely on a single modality. Furthermore, server-side scheduling and incremental updates reduce redundant computation and network usage, lowering latency and communication load. Alternative embodiments may vary the specific algorithms and hardware used while preserving the described data structures and control flows. In one embodiment, the image analysis model may be a different convolutional architecture with dilated convolutions or attention mechanisms. In another embodiment, the speech recognition model may be a conformer model trained with a different loss function such as a connectionist temporal classification loss. In yet another embodiment, the generative AI model may be a different transformer-based architecture or a sequence-to-sequence model with a different decoding strategy such as nucleus sampling, constrained by additional rules. In each case, the server continues to generate structured information, construct prompt sentences, and post-process outputs as described.

The terminal may also vary. In one embodiment, the terminal may be a head-mounted device; in another embodiment, the terminal may be a handheld device with a camera, microphone, and inertial sensors. The same principles of time correlation, compression, encryption, and transmission apply. The user remains the human operator whose natural movements and speech drive sensor input, but the interpretation, fusion, and summarization of that input occur in a manner that is specifically adapted to computer capabilities and optimized beyond mere automation of human reasoning.

Through these embodiments, the server, the terminal, and the user cooperate to realize a system in which generative AI model usage is tightly coupled with structured machine analysis and hardware-based sensing, thereby improving speed, accuracy, and efficiency of computer-implemented situational awareness and avoiding confinement to abstract data manipulation.

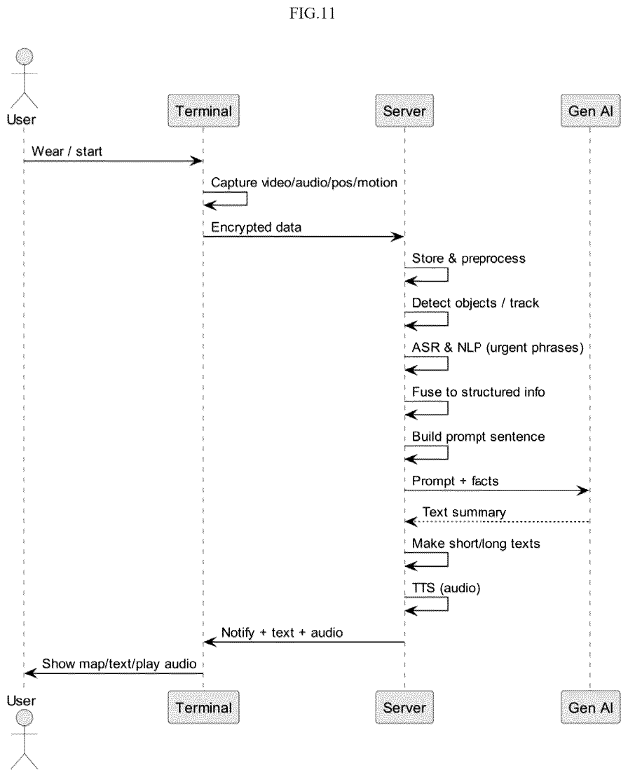

The following describes the processing flow using FIG. 11.

### Step 1:

The user wears the terminal near an accident, incident, or disaster scene.

The user positions the terminal so that the camera has an unobstructed view and the microphone can capture ambient sounds.

Input: The user's physical presence and movements at or near the scene.

Output: A physical configuration in which the terminal's sensors are oriented toward the scene and ready to capture multimodal data.

### Step 2:

The terminal initializes hardware components and timing.

The terminal activates a camera module, a microphone module, a positioning module, and motion sensors using operating system APIs, and starts a system clock or high-resolution timer.

Input: Hardware configuration data and initial sensor states.

Output: Active sensor streams (image, audio, position, motion) and a synchronized timing reference for subsequent data capture.

### Step 3:

The terminal captures raw image information.

The terminal uses the camera module to acquire video frames at a fixed frame rate and resolution, encodes each frame using a video codec, and assigns a capture timestamp to each encoded frame.

Input: Light incident on the camera sensor and current time from the system clock.

Output: A sequence of time-stamped encoded video frames representing the scene from the user's viewpoint.

### Step 4:

The terminal captures raw audio information.

The terminal uses the microphone module to sample ambient sound at a defined sampling rate, groups samples into short buffers, and assigns start and end timestamps to each buffer.

Input: Acoustic signals around the user and current time from the system clock.

Output: A sequence of time-stamped audio buffers representing speech and environmental sounds at the scene.

### Step 5:

The terminal captures position information.

The terminal queries the positioning module for geographic coordinates at regular intervals, receives latitude, longitude, and optional altitude, and associates each sample with a timestamp.

Input: Radio signals or other positioning signals and current time from the system clock.

Output: A time-stamped sequence of position samples representing the terminal's trajectory near the scene.

### Step 6:

The terminal captures motion information.

The terminal reads measurements from motion sensors such as an accelerometer and a gyroscope at a defined sampling rate and assigns timestamps to each measurement vector.

Input: Physical motion of the terminal and current time from the system clock.

Output: A time-stamped sequence of motion vectors representing acceleration and rotation of the terminal.

### Step 7:

The terminal correlates multimodal data into an information group.

The terminal uses timestamps to associate each video frame with the nearest audio buffers, position samples, and motion measurements, and constructs a composite record for each time interval.

Input: Time-stamped video frames, audio buffers, position samples, and motion measurements.

Output: An information group in which image information, audio information, position information, and motion information are logically linked by time.

### Step 8:

The terminal performs compression and packetization.

The terminal compresses video frames into segments, compresses audio buffers if necessary, aggregates corresponding position and motion samples, and packages them into network packets with metadata headers.

Input: Correlated information group including raw or lightly processed sensor data.

Output: A set of compact, structured data packets ready for secure transmission.

### Step 9:

The terminal encrypts and transmits data to the server.

The terminal establishes a secure channel using an encryption protocol, encrypts each data packet, and sends the encrypted packets to the server over a wireless communication interface.

Input: Structured data packets and security parameters for the secure channel.

Output: Encrypted data streams transmitted to the server with preserved integrity and confidentiality.

### Step 10:

The server receives and stores incoming data.

The server terminates the secure channel, decrypts incoming packets, separates video, audio, position, and motion components, and writes them to storage and database structures with appropriate identifiers.

Input: Encrypted data streams from the terminal.

Output: Decrypted and persistently stored multimedia data linked by incident identifier, device identifier, and time.

### Step 11:

The server prepares video frames for analysis.

The server reads stored video segments, decodes encoded frames into pixel arrays, resizes frames to a model-specific resolution, and normalizes pixel values.

Input: Encoded video segments and model configuration parameters.

Output: Preprocessed image tensors suitable for input to a convolutional neural network.

### Step 12:

The server performs object detection on image information.

The server applies a convolutional neural network to each preprocessed frame, computes feature maps, infers bounding boxes and class probabilities, and filters detections using non-maximum suppression.

Input: Preprocessed image tensors and trained neural network weights.

Output: A list of detected objects per frame, each with type label, bounding box coordinates, and confidence score.

### Step 13:

The server performs object tracking and motion estimation.

The server links detected objects across consecutive frames, estimates object trajectories using tracking algorithms and motion information from sensors, and calculates velocities and directions.

Input: Per-frame object detections and time-stamped motion measurements from the terminal.

Output: Time-continuous object tracks with identifiers, positions over time, and motion parameters such as speed and movement direction.

### Step 14:

The server analyzes audio information for speech content.

The server decodes audio buffers into waveform samples, extracts spectral features, applies a speech recognition model, and generates time-aligned text transcriptions.

Input: Time-stamped audio buffers and parameters of the speech recognition model.

Output: Text transcripts with timestamps indicating when each recognized word or phrase was spoken.

### Step 15:

The server extracts urgency-related phrases from transcripts.

The server tokenizes transcripts, feeds token sequences into a language analysis model, classifies tokens or phrases by category and urgency level, and selects those indicating emergency conditions.

Input: Time-aligned transcripts and a trained text classification model.

Output: A set of urgency-related phrases with associated timestamps, categories, and severity scores.

### Step 16:

The server fuses image, audio, position, and motion analysis into structured information.

The server combines object tracks, urgency-related phrases, and position data, maps objects to a real-world coordinate system, and derives higher-level attributes such as lane blockage and hazard presence.

Input: Object detection and tracking results, urgency-related phrases, and time-stamped position information.

Output: Structured information objects describing incident type, number and positions of entities, hazardous factors, traffic obstruction state, and estimated casualties.

### Step 17:

The server constructs a prompt sentence and input text for a generative AI model.

The server formats key elements of the structured information into natural language descriptions, embeds them in a template, and appends instructions that specify summary content, style, and length.

Input: Structured information and a prompt template definition.

Output: An input text containing a prompt sentence and embedded facts, suitable for submission to a generative AI model.

### Step 18:

The server generates a detailed summary using the generative AI model.

The server sends the input text to the generative AI model, receives generated explanation text information, and verifies that required items such as incident type, hazards, and blockages appear in the output.

Input: Prompt-based input text and model inference parameters.

Output: Detailed explanation text information describing the current situation at the scene.

### Step 19:

The server derives role-specific textual summaries.

The server reformats or condenses the detailed explanation text into first explanation text information for stationary operators and second explanation text information for responders in transit, according to predefined rules.

Input: Detailed explanation text information and formatting rules per user role.

Output: Two versions of role-specific explanation text information tailored to different presentation contexts.

### Step 20:

The server converts transit-oriented text into audio announcements.

The server passes the second explanation text information to a speech synthesis engine, selects voice and language parameters, and generates audio samples representing a spoken announcement.

Input: Second explanation text information and speech synthesis configuration.

Output: Audio information containing a spoken summary suitable for playback in a vehicle or on a handheld device.

### Step 21:

The server packages and distributes summaries to terminals.

The server associates explanation text information and audio information with map display information and travel route information, creates notification payloads, and sends them to communication terminal devices.

Input: Role-specific explanation texts, synthesized audio, and location-based map and route data.

Output: Notification messages and content descriptors delivered to terminals for display and playback.

### Step 22:

The terminal receives, displays, and plays the received information.

The terminal decodes notification payloads, requests detailed content from the server if necessary, displays text summaries and map overlays, and plays the audio announcement through a speaker.

Input: Notification messages and referenced incident content from the server.

Output: Visual and auditory presentations that convey situational information to the user in real time.

### Step 23:

The user responds based on the presented information.

The user observes the text, map, and audio, adapts behavior such as driving route or on-site preparation, and optionally enters status updates or additional observations through the terminal interface.

Input: Visual and auditory information presented by the terminal.

Output: Physical responses in the real world and digital feedback data that can be collected by the terminal and sent back to the server for further analysis and updates.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional situation-awareness systems that process image and audio data in emergency, traffic, or autonomous-driving scenarios typically rely on fixed, rule-based logic or narrowly trained machine learning models to generate control decisions and notifications. Such systems suffer from several technical limitations in computer technology itself. First, conventional architectures often treat perception, risk estimation, and instruction generation as isolated modules, resulting in fragmented data flows and inefficient use of computing resources. Structured sensor outputs (for example, object positions, classifications, and predicted trajectories) are not effectively leveraged as unified context, which increases latency and reduces robustness when conditions change rapidly.

Second, even when large-scale models are used, their deployment is usually limited to perception (such as object detection), while high-level reasoning and instruction generation remain hard-coded. This rigid design makes it difficult for the computer system to adapt to complex, multi-agent scenarios, such as simultaneous pedestrian crossings and approaching emergency vehicles, without extensive manual reprogramming. As a result, the system cannot fully exploit the expressive reasoning capability of modern generative models.

Third, existing systems lack a structured mechanism for converting rich, multimodal sensor data into prompt sentences that are suitable for generative AI models, and for converting the natural-language outputs of such models back into precise, machine-executable control parameters. Without this bidirectional transformation layer, generative models cannot be safely and predictably integrated into real-time control loops, and their outputs cannot be reliably used to improve low-level motion planning or user-facing explanations. Fourth, conventional systems do not provide a feedback loop in which logged situation data, control decisions, generative model outputs, and user operation histories are systematically collected and used as training data to update both perception models and prompt-generation strategies. This absence of continuous learning prevents the computer system from improving its own models and internal representations over time, thereby limiting the scalability and adaptability of the overall computing architecture.

Accordingly, there is a need for an improved computer-implemented system that (i) acquires and preprocesses multimodal situation data from wearable and vehicle-mounted sensing equipment, (ii) performs machine-learning-based recognition and risk prediction, (iii) generates structured, text-based prompt sentences for a generative AI model, (iv) parses natural-language outputs from the generative AI model into concrete control parameters and user explanations, and (v) logs and reuses such data to automatically retrain and refine the underlying models. Such an arrangement improves the functioning of the computer system itself by optimizing data flow, enabling dynamic reasoning through generative models, and enhancing the accuracy and responsiveness of control and information-provision operations in complex environments.

The specific processing by the specific processing unit 290 of the data processing device 12 in Application Example 1 is realized by the following means.

The present invention provides a server comprising a processor and a memory storing instructions, wherein the instructions, when executed by the processor, cause the server to acquire situation data from at least one wearable image acquisition device and a plurality of types of detection devices mounted on a moving body; preprocess the situation data and transmit the preprocessed situation data between the moving body and the server by using a secure communication scheme; perform machine-learning-based recognition processing on the situation data to identify objects and acoustic events in a surrounding environment and to predict future behaviors of the objects and collision risks; generate a text-based prompt sentence by combining structured information, including at least positions, speeds, classifications, predicted trajectories, and risk indices of the objects, with natural-language contextual descriptions, and input the text-based prompt sentence into a generative AI model to obtain a natural-language output relating to situation evaluation and response instructions; parse and convert the natural-language output into machine-readable control parameters, including at least a numerical speed target, a stop distance, and a type of avoidance action; generate, based on the control parameters, operation control instructions that include at least a speed, a route, and a stop position of the moving body and an outline explanation sentence for related persons; transmit the operation control instructions to a control apparatus on the moving body so that the operation control instructions are converted into travel control signals; provide the outline explanation sentence to related persons by at least one of voice synthesis processing and display processing; and record the situation data, the operation control instructions corresponding to the natural-language output of the generative AI model, and an operation history from a user, and update at least one of the machine-learning-based recognition processing and generation rules for the text-based prompt sentence using the recorded data as learning data. This enables an integrated computer-implemented architecture in which multimodal sensor data are transformed into optimized prompt sentences for a generative AI model, natural-language outputs of the generative AI model are deterministically converted into precise control parameters and explanatory information, and logged interactions are fed back into the system to improve perception accuracy, risk assessment, prompt design, and control performance, thereby enhancing the overall efficiency, adaptability, and technical capabilities of the underlying computer system.

The term “processor” refers to an electronic data processing unit, such as a central processing unit or a graphics processing unit, that executes instructions to perform arithmetic, logical, control, and input/output operations in order to implement the functions of the system.

The term “memory” refers to a hardware storage resource, such as volatile memory or non-volatile memory, that stores instructions and data for access and execution by the processor. The term “situation data” refers to data representing an environment and an event state, including at least image data, audio data, position data, motion data, and other sensor outputs obtained from one or more sensing devices.

The term “wearable image acquisition device” refers to a portable device configured to be worn by a person and to capture at least image data and optionally audio data of a surrounding environment.

The term “detection device” refers to a sensing component mounted on a moving body and configured to detect physical quantities of an environment, including at least one of optical information, distance information, motion information, and sound information.

The term “moving body” refers to any mobile apparatus that is capable of changing its position autonomously or under control, including at least a vehicle, a robot, or a mobile platform.

The term “preprocess” refers to performing at least one operation of filtering, compressing, normalizing, transforming, or formatting raw data to obtain data suitable for storage, transmission, or further analysis.

The term “secure communication scheme” refers to a communication protocol that provides at least confidentiality and integrity for transmitted data, by using encryption, authentication, or both, between two or more computing entities.

The term “machine-learning-based recognition processing” refers to processing that uses a trained model, such as a neural network or other statistical model, to classify, detect, or segment patterns from input data, without relying solely on fixed rule-based logic.

The term “object” refers to a physical entity present in a surrounding environment, including at least a person, a vehicle, an obstacle, a structure, or any other identifiable target detected from situation data.

The term “acoustic event” refers to an occurrence represented by audio data, including at least a siren, a horn, a spoken utterance, an impact sound, or background noise pattern that is analyzed by audio processing.

The term “future behavior” refers to a predicted state, motion, or trajectory of an object over a time interval following a current time, computed based on current and past situation data.

The term “collision risk” refers to a likelihood or severity measure indicating a possibility that the moving body will come into contact with an object within a future time interval.

The term “text-based prompt sentence” refers to text data that encodes, in natural language or structured textual form, a description of a situation and a task, and that is provided as input to a generative AI model.

The term “generative AI model” refers to a trained computational model, such as a large language model or other generative model, that generates outputs including natural-language text, based on input text or other data.

The term “natural-language output” refers to text generated by the generative AI model in a human language, expressing at least a situation evaluation, an instruction, an explanation, or a recommendation.

The term “structured information” refers to data arranged according to a predefined format or schema, such as key-value pairs, tables, or lists, that represent attributes of objects, including at least positions, speeds, classifications, predicted trajectories, and risk indices.

The term “position” refers to a spatial location of an object or the moving body, represented in at least one coordinate system.

The term “speed” refers to a magnitude of movement per unit time of an object or the moving body, optionally including direction as velocity.

The term “classification” refers to a categorical label assigned to an object, indicating its type, such as a person, a vehicle, or a structure, obtained by recognition processing.

The term “predicted trajectory” refers to a time-sequenced series of estimated future positions of an object or the moving body.

The term “risk index” refers to a numerical or categorical value that quantifies a level of risk associated with a predicted event, such as a potential collision.

The term “control parameter” refers to a numerical or symbolic value used as input to a control algorithm, including at least a target speed, a stop distance, or a type of avoidance action.

The term “operation control instruction” refers to data that specifies how the moving body should be operated, including at least a target speed, a route, and a stop position, derived from control parameters.

The term “route” refers to a sequence of locations, segments, or waypoints that defines a path to be followed by the moving body.

The term “stop position” refers to a location at which the moving body is instructed to reduce its speed to zero or to a predetermined low speed.

The term “control apparatus” refers to a computing and actuation system on the moving body that receives operation control instructions and generates corresponding travel control signals.

The term “travel control signal” refers to a signal transmitted to one or more actuators of the moving body, controlling at least acceleration, deceleration, steering, or braking.

The term “outline explanation sentence” refers to a natural-language description that summarizes at least a current situation, a risk, or an operation control instruction for a related person.

The term “related person” refers to an individual involved in or affected by an event, including at least an operator, a passenger, a responder, or a remote supervisor.

The term “voice synthesis processing” refers to a process of converting text data into audio data that represents spoken language, using a text-to-speech technique.

The term “display processing” refers to a process of rendering text, graphics, or symbols on a visual output device to present information to a person.

The term “operation history” refers to a record of inputs, actions, or commands provided by a user or automatically generated by a system during operation.

The term “user” refers to a person who interacts with or supervises the system, including at least a driver, a passenger, an operator, or a remote controller.

The term “learning data” refers to data used to train, fine-tune, or update a machine learning model, including at least situation data, corresponding control instructions, generative model outputs, and operation history.

The term “generation rules for the text-based prompt sentence” refers to algorithms, templates, or parameterized procedures that define how structured information and context are converted into one or more prompt sentences for the generative AI model.

In an embodiment, a system includes a server, at least one terminal mounted on a moving body, and optionally at least one terminal in the form of a wearable image acquisition device. The system implements the claimed functions by executing computer programs on general-purpose or specialized hardware platforms.

### A. Overall Architecture

Server comprises at least one processor, such as a multi-core central processing unit and optionally one or more graphics processing units, and at least one memory device, such as volatile memory and non-volatile memory. Server executes operating system software, such as a general-purpose operating system, and middleware for communication and machine learning execution, such as container orchestration software and a deep-learning framework. Terminal comprises an embedded processor, such as a vehicle electronic control unit, a memory device, and a plurality of detection devices, such as cameras, distance sensors, motion sensors, and sound sensors. Terminal optionally further comprises a wireless communication module, such as a cellular modem or a short-range radio interface, and a human-machine interface, such as a display device and a speaker. In some implementations, terminal includes an in-vehicle control apparatus that interfaces with mechanical actuators through an in-vehicle network bus.

User interacts with the system through the terminals, for example by wearing a wearable image acquisition device, by boarding the moving body as a driver or passenger, or by operating a supervisory interface.

### B. Hardware and Software Components

Terminal uses image sensors configured as forward-facing and side-facing cameras, a distance sensor configured as a laser-based scanner, a radio-based distance and speed sensor configured as a radar unit, a sound sensor configured as a microphone, and navigation sensors configured as a position sensor and an inertial sensor. Terminal drives these sensors using sensor driver software and middleware such as a robotics communication middleware or an automotive standard software platform. Terminal processes raw sensor streams using local programs that perform filtering, compression, and feature extraction.

Terminal encodes image frames using a compression library such as a video codec library, compresses three-dimensional point clouds using a point-cloud processing library, and extracts audio features using a signal-processing library. Terminal uses a communication stack such as a transport protocol stack and a security library to establish an encrypted channel to server. Terminal also implements a local control stack that receives control parameters from server and converts them into actuator commands by executing numerical algorithms such as proportional-integral-derivative control or model predictive control. Server uses network interface hardware and a software stack including a web server or remote procedure call framework, and a cryptographic library, to receive encrypted messages from multiple terminals concurrently. Server stores heavy sensor payloads in a data store such as a distributed object store, and stores metadata such as timestamps, positions, and identifiers in a structured data store such as a relational database system or a key-value store.

Server executes machine learning programs using a deep-learning framework such as a tensor-based computation framework. Server deploys trained models for image-based object detection, three-dimensional object detection, trajectory prediction, audio classification, and natural-language generation and interpretation. Server executes these models on a graphics processing unit or another accelerator to achieve low latency and high throughput.

### C. Situation Data Processing and Model Structures

Server receives situation data from terminal in the form of structured messages. Each message comprises at least time-stamped image sequences, point-cloud arrays, radar feature matrices, audio feature sequences, and state variables of the moving body. Server represents image data as multi-dimensional arrays of pixel intensities, point-cloud data as arrays of three-dimensional coordinates and optionally reflectance values, radar data as two-dimensional matrices over distance and frequency or velocity, and audio features as spectral coefficients or learned feature vectors.

Server performs machine-learning-based recognition processing by applying different neural network architectures to these data types. For image data, server uses a convolutional neural network architecture with multiple convolutional layers, pooling layers, and fully connected layers. For example, server instantiates a detector model that receives a three-channel image tensor and outputs a set of bounding boxes with class probabilities and confidence scores. The network uses convolution kernels with fixed sizes, non-linear activation functions such as rectified linear units, and normalization layers to stabilize training and inference. Server optionally applies a region proposal mechanism or an anchor-based scheme for object localization.

For three-dimensional point-cloud data, server uses a network architecture that voxelizes or pillars the input space and then applies convolutional operations on voxel or pillar features, followed by a detection head that outputs three-dimensional bounding boxes and motion vectors. Server organizes point clouds into grid cells and accumulates statistics such as mean position, intensity, and number of points per grid cell, then passes these statistics through convolutional layers and feature aggregation layers.

For radar data, server applies a short-time Fourier transform or similar spectral transformation to convert time-domain radar returns into range-Doppler maps, and then uses a neural network or a classical signal-processing algorithm to detect objects and estimate their relative velocity. For audio data, server constructs time-frequency representations, such as Mel-spectrograms, and applies a convolutional neural network or a sequence model to classify sound events such as sirens and horns.

Server then uses a tracking and prediction module. Server combines detected objects from different sensors by using a filter algorithm, such as an extended Kalman filter or a particle filter, to maintain consistent identifiers and to estimate positions and velocities over time. Server feeds the tracked object sequences into a trajectory prediction model, for example a recurrent neural network with gated units or a transformer-based sequence model. The trajectory prediction model receives as input a sequence of past positions, velocities, and contextual features such as lane geometry and traffic light status and outputs a sequence of predicted future positions for each object over a finite time horizon. Server trains this trajectory prediction model using supervised learning with an error function such as mean squared error between predicted and actual positions.

Server computes collision risk for each predicted trajectory by calculating quantitative metrics such as minimum distance between trajectories, time-to-collision, and probability estimates derived from uncertainty in predictions. Server may implement a risk-estimation network that receives as input a feature vector describing ego path and surrounding trajectories and outputs a risk index between predetermined bounds. This risk-estimation network can be a feed-forward neural network trained with a loss function such as cross-entropy or a regression loss, using labeled training data representing safe and unsafe scenarios.

### D. Prompt Sentence Generation and Generative AI Interaction

Server constructs a text-based prompt sentence to provide a compact but expressive representation of the recognized situation to a generative AI model. Server first encodes structured information into a canonical internal representation, such as a list of objects with attributes (identifier, class, position, speed, predicted trajectory, and risk index). Server then applies a prompt-generation program that maps this internal representation into a human-readable textual description using predefined templates and parameterized rules.

For example, server can generate the following prompt sentence:

“Current scene:
Ego vehicle speed: 40 km/h, lane: straight, position: urban intersection.
Detected pedestrian: crossing from right to left, distance: 12 meters ahead, predicted time-to-cross ego lane: 2.0 seconds.
Detected emergency vehicle: approaching from behind, siren detected, distance: 60 meters, speed: 70 km/h.

### Task:

Assess the collision risk for the ego vehicle over the next 5 seconds and propose concrete driving instructions (for example, decelerate to X km/h, stop before crosswalk, yield to emergency vehicle).

Output the recommendations in a structured bullet-point list.”

Server may also generate other prompt sentences, such as:

“Given the following objects and predicted trajectories around an autonomous vehicle, evaluate collision risk for the next 5 seconds and propose safe driving actions. Provide specific numeric targets for speed and distance.”

or

“Explain the following control decision to a non-expert passenger:

‘Vehicle decelerated from 40 km/h to 0 km/h before the crosswalk, waited 5 seconds for a pedestrian to cross, and remained stopped to yield to an approaching ambulance.’ Use simple language and keep the explanation within three sentences.” Server uses a generative AI model implemented as a large language model. The large language model comprises multiple transformer layers, each including a multi-head self-attention mechanism, feed-forward sub-layers, layer normalization, and residual connections.

The model is pre-trained on large-scale text corpora using an objective such as masked language modeling or next-token prediction, and optionally fine-tuned on domain-specific corpora involving traffic scenarios, safety instructions, and explanatory text.

Server sends the generated prompt sentence to the large language model and receives a natural-language output. The generative AI model produces the output by computing context-dependent token probabilities using the attention mechanism and generating tokens sequentially according to sampling or decoding rules such as greedy decoding or beam search.

The model parameters are adjusted during pre-training and fine-tuning using an optimization method such as stochastic gradient descent or an adaptive variant, with an error function such as cross-entropy loss over target tokens.

Server parses the natural-language output to extract control parameters and explanation elements. Server can constrain the generative AI output by including key phrases or formatting instructions in the prompt, such as requesting bullet points with explicit numeric values. Server then uses a parsing module, such as a rule-based parser or another lightweight classifier, to identify phrases like “decelerate to 20 km/h,” “stop before the crosswalk,” and “yield to the ambulance,” and to convert them into standardized control parameters.

### E. Control Instruction Generation and Technical Effects

Server generates operation control instructions for the moving body using a motion-planning module. Server receives the high-level control parameters derived from the generative AI output and constructs a physically feasible trajectory for the moving body. Server uses algorithms such as model predictive control or sampling-based planning to ensure that the trajectory respects vehicle dynamics, comfort constraints, and environmental constraints. Server represents the planned trajectory as a time-ordered sequence of waypoints and associated target speeds and accelerations. Server also derives a stop position and optional alternative maneuvers, such as lane changes or lateral shifts. Server encodes this information into a message containing fields for target speed profile, target path coordinates, stop command flags, and identifiers for maneuvers such as “yield_to_emergency_vehicle.” Terminal receives the operation control instructions and uses local processor resources to convert the instructions into actuator-level commands. Terminal runs control algorithms that compare current state measurements from sensors with the target trajectory and compute control actions by minimizing deviations. By combining server-generated high-level plans with fast local feedback loops, the system achieves both accurate response to complex, multi-agent scenarios and robust low-level control.

This architecture improves computer technology in several ways. By converting high-dimensional sensor data into structured internal representations and then into optimized prompt sentences, server reduces the dimensionality and redundancy of data passed to the generative model, thereby decreasing communication load and inference time. By using neural networks for perception and prediction in combination with a generative model for high-level reasoning, server achieves more robust and adaptable decision-making than conventional rule-based systems, without requiring human operators to encode all possible scenarios.

Moreover, the explicit parsing of natural-language outputs into machine-executable control parameters avoids the ambiguity that normally arises in language-only interfaces, enabling deterministic control behavior despite the use of generative models. The combination of trajectory prediction networks and risk indices with generative prompts allows server to focus the generative model on the most critical aspects of the scene, which leads to improved accuracy in risk assessment and corresponding control decisions.

### F. Learning and Adaptation

Server records situation data, generated prompt sentences, natural-language outputs, operation control instructions, and user operation histories. Server stores these records in a training database. Server periodically runs training or fine-tuning processes to improve both the perception models and the prompt-generation rules.

For perception models, server uses supervised learning or semi-supervised learning. Server samples recorded scenes, extracts ground-truth labels for object classes and trajectories, and computes an error function such as mean squared error for trajectory prediction and cross-entropy for classification. Server updates network weights by backpropagation and gradient-based optimization. Server may apply data augmentation methods, such as random rotations, translations, noise injection, and intensity scaling, to increase robustness.

For prompt-generation rules, server analyzes the effectiveness of different prompt patterns by measuring performance metrics such as collision rates, user satisfaction, or expert ratings on generated plans. Server adjusts templates, phrasing, and ordering of information in the prompt sentences to guide the generative model toward more precise and concise outputs. This adjustment can be implemented by updating rule sets, retraining an auxiliary model that proposes prompt structures, or fine-tuning the generative model using reinforcement learning techniques based on outcome rewards.

By using this feedback loop, server gradually improves recognition accuracy, prediction reliability, and control behavior over time. This continuous adaptation is not achievable by simple human-written rules or static automation scripts and constitutes an enhancement of the internal functioning of the computer system itself, rather than a mere automation of human judgment.

### G. Alternative Embodiments and Variations

Server can be configured in different deployment modes. In one embodiment, most heavy computation, including deep neural network inference and generative AI processing, occurs on central server hardware, with terminals performing only light pre-processing and actuation.

In another embodiment, terminals with sufficient processing capacity execute some or all perception and trajectory prediction locally, and server focuses primarily on aggregating situational data from multiple moving bodies and generating higher-level coordination instructions.

Terminal can be implemented in different forms. In one embodiment, terminal is a vehicle control unit interfaced with multiple sensors and actuators. In another embodiment, terminal is a wearable smart device with an integrated camera and microphone, which captures situation data in an incident scene and streams it to server for analysis and announcement generation. In yet another embodiment, terminal is a stationary monitoring unit installed at an intersection or other critical location.

User may interact with the system at different levels. In a highly automated mode, terminal automatically follows operation control instructions from server without user intervention, while still providing outline explanation sentences to keep the user informed. In a supervised mode, user is allowed to confirm, modify, or override certain high-level instructions using an interface, such as buttons or touch input. Terminal logs these interventions and transmits them to server, which uses them as part of the learning data for model and prompt refinement.

The generative AI model can be replaced or complemented by other generative architectures, such as encoder-decoder language models or multi-modal generative models that directly accept structured representations as input. The prompt-generation mechanism can also be adapted to different languages and domain-specific terminologies, as long as the system maintains a mapping between structured internal representations and textual prompts that preserve the essential technical features of the situation.

By organizing data in specific structures, choosing dedicated network architectures and training procedures, and implementing a bi-directional transformation between structured sensor-derived data and natural-language-level reasoning, the system achieves improved processing speed, higher decision accuracy, better data management, and reduced communication loads compared with conventional architectures. The combination of these features yields concrete technical effects in the control of physical moving bodies and in the real-time provision of situation information, and therefore constitutes a technical improvement to computer technology rather than a mere implementation of an abstract idea.

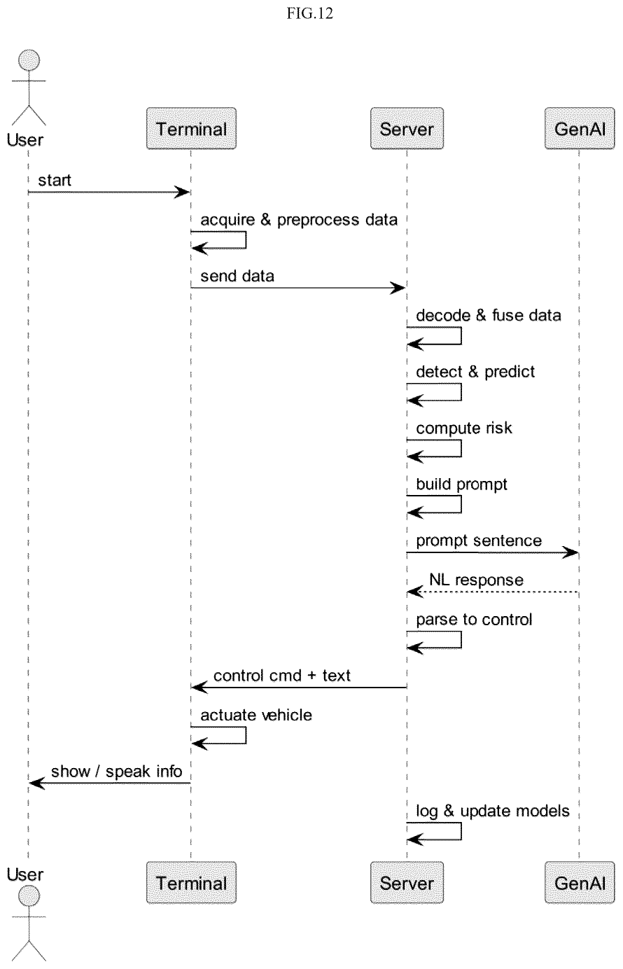

The following describes the processing flow using FIG. 12.

### Step 1:

Terminal acquires raw situation data.

Terminal uses onboard sensors, including at least cameras, distance sensors, motion sensors, and sound sensors, to capture image frames, three-dimensional point clouds, motion measurements, audio waveforms, and position data from the surrounding environment.

Input: analog or low-level sensor signals from the sensors and internal state signals such as vehicle speed and position.

Processing: Terminal converts the sensor signals into digital data structures, for example, RGB image arrays, point-cloud coordinate lists, acceleration and yaw-rate samples, audio sample buffers, and position coordinates. Terminal timestamps each data structure using an internal clock and associates sensor identifiers and calibration parameters.

Output: time-stamped, sensor-specific digital data packets stored in terminal memory and ready for preprocessing.

### Step 2:

Terminal performs local preprocessing and feature extraction.

Terminal reads the raw digital data packets from memory and reduces data size and noise to prepare them for transmission and further analysis.

Input: time-stamped images, point clouds, motion samples, audio buffers, and position data generated in Step 1.

Processing: Terminal downsamples and compresses image frames using a video compression algorithm, removes outlier points and distant clutter from point clouds using filtering algorithms, aggregates motion samples into short-window summaries, and computes audio features such as Mel-spectrograms or cepstral coefficients. Terminal normalizes each data type, for example by scaling pixel values, centering point-cloud coordinates, and standardizing feature vectors, and packages the results into a structured message format with headers and metadata fields.

Output: preprocessed and feature-enriched sensor messages containing compressed images, filtered point clouds, motion summaries, audio features, and metadata.

### Step 3:

Terminal encrypts and transmits situation data to server.

Terminal ensures secure communication by encrypting the preprocessed messages and sending them over a wireless link.

Input: structured sensor messages produced in Step 2 and security credentials stored in terminal memory.

Processing: Terminal establishes a secure channel to server using a handshake protocol, negotiates encryption parameters, and applies an encryption algorithm to each outgoing message. Terminal segments large messages into network packets, attaches sequence numbers and checksums, and uses a transport protocol stack to send the packets via a wireless interface.

Output: encrypted data packets transmitted over a network to server, containing all preprocessed situation data and associated metadata.

### Step 4:

Server receives, decrypts, and stores situation data.

Server terminates the secure connection from terminal, reconstructs the original messages, and organizes them in storage.

Input: encrypted network packets received from terminal, including sequence numbers and integrity checks.

Processing: Server uses a decryption algorithm to recover the original structured sensor messages, verifies integrity using checksums or message authentication codes, and discards or flags any corrupted or incomplete packets. Server parses the structured format to extract images, point clouds, motion features, audio features, and metadata such as timestamps and positions, and writes large binary payloads to a data store while inserting index records into a metadata database.

Output: decrypted, parsed situation data stored in server-side repositories, organized by time, terminal identifier, and sensor type, and ready for analysis.

### Step 5:

Server assembles synchronized analysis units.

Server groups incoming sensor data by time into coherent units for joint processing.

Input: stored images, point clouds, motion features, audio features, and metadata records originating from one or more terminals.

Processing: Server queries the metadata database to locate data items whose timestamps fall within a selected analysis window. Server aligns the data streams by interpolating or buffering to synchronize data from different sensors, discards outdated or severely delayed data, and constructs an analysis unit that contains all available sensor inputs for a given time interval and moving body.

Output: time-aligned analysis units, each consisting of synchronized images, point clouds, radar-derived features, audio features, and state variables for a particular moving body at a given time window.

### Step 6:

Server performs multimodal recognition of objects and acoustic events.

Server applies machine-learning-based recognition models to detect and classify entities and events in the environment.

Input: analysis units assembled in Step 5, including synchronized images, point clouds, radar features, audio features, and state variables.

Processing: Server feeds image arrays into a convolutional neural network to detect objects and obtain bounding boxes, class labels, and confidence scores. Server feeds point clouds into a three-dimensional detection network to obtain three-dimensional bounding boxes and velocities. Server processes radar features with signal-processing and neural models to estimate distances and relative speeds of reflectors. Server feeds audio features into an audio classification network to detect sound events such as sirens and horns and their approximate direction. Server fuses outputs from the different models by matching detections that refer to the same physical object and computing a unified state estimate for each object.

Output: a list of recognized objects and acoustic events, each with an identifier, class label, estimated position, velocity, and detection confidence, representing the scene at a given time.

### Step 7:

Server tracks objects and predicts future trajectories.

Server estimates how each recognized object is likely to move over a future horizon.

Input: lists of recognized objects from Step 6 and historical state estimates stored from previous analysis units.

Processing: Server uses a tracking algorithm to associate current detections with historical tracks, update state estimates for each object, and maintain unique identifiers. Server then supplies sequences of past positions, velocities, and contextual features for each track to a trajectory prediction network, such as a recurrent or transformer-based neural network. The network computes future positions for each object over designated time steps by applying learned transformation weights to the input sequences and minimizing predicted error during training.

Output: predicted trajectories for all tracked objects, including a sequence of future positions and velocities for each object, together with confidence measures.

### Step 8:

Server computes collision risks relative to the moving body.

Server evaluates how predicted trajectories interact with the planned or current path of the moving body.

Input: predicted trajectories from Step 7, current and planned path of the moving body, and associated state variables such as current speed and lane.

Processing: Server calculates distances between the moving body's path and each predicted trajectory at each future time step, computes time-to-collision where paths intersect or approach within a threshold, and evaluates a risk index using a function that combines distance, relative speed, and prediction uncertainty. Server optionally applies a risk-assessment network that receives features such as minimum distance, angle of approach, and object class and outputs a numeric risk score.

Output: a set of risk indices associated with object-moving-body pairs, and identification of high-risk scenarios including potential collision points and critical time intervals.

### Step 9:

Server generates a prompt sentence for a generative AI model.

Server constructs a text-based description that encodes the current scene and required reasoning task.

Input: recognized objects and events from Step 6, predicted trajectories from Step 7, risk indices from Step 8, and moving-body state information.

Processing: Server maps the structured internal representation to a human-readable text by applying template-based rules. Server selects relevant objects and events that exceed predefined thresholds of relevance, such as high risk or proximity, and inserts their attributes, including type, distance, speed, and time-to-collision, into sentence templates. Server organizes the information into sections, for example “Current scene” and “Task,” and adds explicit instructions on the desired output format for the generative AI model.

Output: a text-based prompt sentence that concatenates scene descriptions and task instructions into a coherent natural-language input for the generative AI model.

### Step 10:

Server obtains a natural-language output from the generative AI model.

Server sends the prompt sentence to the generative AI model and receives recommendations and explanations.

Input: text-based prompt sentence generated in Step 9 and model configuration parameters such as maximum length and decoding strategy.

Processing: Server feeds the prompt to the generative AI model, which internally tokenizes the text, applies multiple layers of attention and non-linear transformations, and computes probability distributions over possible next tokens at each step. The model generates an output sequence of tokens that form sentences describing risk evaluation and recommended driving actions. Server then detokenizes the sequence into plain text.

Output: natural-language output from the generative AI model, including at least an assessment of collision risk, recommended actions such as deceleration or stopping, and explanatory phrases.

### Step 11:

Server parses the natural-language output into control parameters.

Server converts the generative AI model's text into machine-executable values.

Input: natural-language output obtained in Step 10 and a set of parsing rules or auxiliary classifiers.

Processing: Server applies pattern matching, keyword extraction, and numerical value detection to identify expressions such as “decelerate to 20 km/h,” “stop before the crosswalk,” or “yield to the emergency vehicle.” Server maps these expressions to standardized control parameters including target speed values, stop distances along the path, and types of avoidance maneuvers. Server validates the extracted parameters against safety and constraint rules, adjusting or discarding any values that fall outside permitted ranges.

Output: a structured set of control parameters specifying numeric targets for speed, stopping, and maneuver selection, together with a cleaned explanation text for user presentation.

### Step 12:

Server generates operation control instructions.

Server converts control parameters into a planned motion and control messages for the moving body.

Input: control parameters from Step 11, current moving-body state, and environment constraints such as lane geometry and traffic rules.

Processing: Server computes a feasible trajectory by solving an optimization problem that minimizes deviations from the desired control parameters while respecting dynamic limits and obstacle constraints. Server discretizes the resulting trajectory into waypoints and associated speed and acceleration targets, and sets flags or identifiers indicating critical actions such as stopping or yielding. Server encapsulates this data in an operation control instruction message with fields for speed profile, route geometry, stop position, and maneuver type.

Output: operation control instructions suitable for direct execution by the terminal's control apparatus, and an outline explanation sentence summarizing the planned actions.

### Step 13:

Terminal executes control instructions and actuates the moving body.

Terminal receives the instructions from server and converts them into actuator commands.

Input: operation control instructions from Step 12 and current local sensor readings of speed, steering angle, and other state variables.

Processing: Terminal interprets the control instructions, compares the target trajectory with its current state, and uses control algorithms to compute actuator signals that adjust throttle, braking, and steering. Terminal sends these signals over an in-vehicle network to the appropriate actuators, and continuously monitors feedback to update control outputs and track the planned trajectory.

Output: physical actuation of the moving body, including changes in speed, route, and stopping behavior that correspond to the operation control instructions.

### Step 14:

Terminal presents explanatory information to user.

Terminal informs user of current actions and situation in an understandable form.

Input: outline explanation sentence received from server in Step 12 and local visualization data such as the current trajectory and detected objects.

Processing: Terminal renders the explanation sentence as text on a display and optionally converts the text into synthesized speech. Terminal overlays graphical indicators such as highlighted objects, projected paths, and stop positions on a map or camera view, aligning them with the actual environment.

Output: visible and audible information presented to user, explaining why the moving body is decelerating, stopping, or yielding in the current scene.

### Step 15:

Server logs data and updates models and prompt rules.

Server records the entire interaction to improve future performance.

Input: situation data from Steps 4 to 8, prompt sentences from Step 9, generative AI outputs from Step 10, control parameters and instructions from Steps 11 and 12, and user operation history including confirmations or overrides gathered by terminal.

Processing: Server stores these elements in a training database with identifiers linking related records. Server periodically retrieves logged data to train or fine-tune perception models, trajectory prediction models, risk-assessment networks, and prompt-generation rules. Server computes error metrics such as prediction error and decision outcome scores, updates model weights through gradient-based optimization, and modifies prompt templates or parsing rules to improve clarity and control accuracy.

Output: updated model parameters and revised prompt-generation and parsing rules that enhance recognition accuracy, risk evaluation quality, and control decisions in subsequent runs of the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional emergency information systems that collect image and audio data from user devices and generate situation summaries suffer from several technical limitations that restrict their effectiveness and scalability in real-world deployments.

First, existing systems typically process video and audio streams independently and focus primarily on the detection of physical objects and keyword extraction. Such systems do not consistently synchronize heterogeneous sensor modalities, such as images, audio signals, position data, and posture data, at a fine-grained time resolution within the data acquisition and transport pipeline. As a result, the server-side analysis modules often operate on loosely correlated or partially misaligned data. This leads to incomplete or inconsistent feature sets for downstream algorithms, degrades recognition accuracy for dynamic scenes, and increases compute overhead due to redundant or corrective processing.

Second, while some systems apply machine learning-based object recognition or speech recognition, they generally lack a unified, processor-level mechanism to estimate emotional states of multiple users from multimodal signals and to incorporate such emotional states into risk evaluation. Emotion-related processing, if present, is frequently implemented as an independent overlay or post-processing tool that does not directly feed into a core hazard scoring pipeline. This separation causes increased latency, duplicate computation on overlapping data, and poor utilization of computation resources on the server, thereby limiting the responsiveness and reliability of emergency assessments.

Third, conventional architectures do not exploit generative AI models in a structured, system-level manner that is tightly coupled with quantitative hazard metrics and emotional indicators. In many cases, text templates or fixed rule-based message generators are used, which are not flexible enough to adapt to diverse, rapidly changing conditions. When generative models are used, they are often accessed via ad-hoc calls with unstructured prompts, which complicates reproducibility, traceability, and deterministic behavior. This makes it difficult for a server to reliably generate differentiated outputs for different recipients, such as detailed situation reports for responder organizations and personalized guidance messages for affected individuals.

Fourth, the lack of an integrated pipeline that joins multimodal sensing, synchronized data structuring, multi-level risk scoring (physical, subjective, psychological), and prompt-based interaction with generative AI models results in higher network and computation costs. Servers must perform repeated parsing and reconstruction of partially processed data, and clients may transmit redundant or inefficiently encoded sensor streams. These inefficiencies can impede real-time operation, particularly when many users are present in a crowded scene and when the network bandwidth is constrained.

Accordingly, there is a need for an improved computer-implemented system and server architecture that: (i) efficiently acquires and synchronizes multimodal sensor data (image, audio, position, posture) from user devices; (ii) performs integrated, multi-stage analysis of physical objects, acoustic events, and emotional states on the server using a processor-level pipeline; (iii) computes a comprehensive hazard index that reflects physical hazard, subjective urgency, and psychological crowd tension; and (iv) programmatically constructs structured prompt sentences based on these quantitative indicators and uses them to drive a generative AI model to produce differentiated, context-aware situation reports and guidance messages in a reproducible and resource-efficient manner. Such an architecture should improve utilization of computational resources, reduce latency and bandwidth consumption, and increase the accuracy and usefulness of the generated announcements compared to conventional systems.

The specific processing by the specific processing unit 290 of the data processing device 12 in Example 2 is realized by the following means.

The present invention provides a server comprising a processor and a memory storing instructions which, when executed by the processor, cause the processor to acquire, from an information processing device worn or carried by a human located at or near an accident, incident, or disaster site, image information, audio information, position information, and posture information by using an imaging function, a sound acquisition function, a position information acquisition function, and a posture information acquisition function of the information processing device, associate the acquired image information, audio information, position information, and posture information with common time information to generate a plurality of types of synchronized time-series data, and perform predetermined compression processing and encryption processing on the plurality of types of synchronized time-series data to generate transmission data for network-efficient and secure transport; to receive the encrypted transmission data from the information processing device via a communication interface, perform decryption processing on the encrypted transmission data, perform decoding processing on image information contained in the decrypted transmission data to generate analysis image information, perform decoding processing on audio information contained in the decrypted transmission data to generate analysis audio information, and associate the position information and the posture information with the analysis image information and the analysis audio information to generate an analysis data set that is indexed and structured for subsequent multimodal analysis; to execute image recognition processing on the analysis image information to identify physical objects at the site and movement states of the physical objects, execute speech recognition processing and acoustic analysis processing on the analysis audio information to extract conversation content, important words, and acoustic events, and estimate emotional states of humans present at the site based on at least a part of the analysis image information, the analysis audio information, and the posture information by performing facial analysis processing, acoustic emotion analysis processing, text emotion analysis processing, and posture analysis processing and fusing results thereof into an emotion index for each human; and to calculate, based on information relating to the physical objects, information relating to the acoustic events, and information relating to the emotional states, a physical hazard level, a subjective tension level, and a psychological tension level, calculate a comprehensive hazard index by integrating the physical hazard level, the subjective tension level, and the psychological tension level, generate at least one prompt sentence by structuring, as a natural language instruction sentence, condition information including the information relating to the physical objects, the information relating to the acoustic events, the information relating to the emotional states, and the comprehensive hazard index, input the at least one prompt sentence into a generative AI model to generate situation report text for organizations involved in emergency response and guidance text for humans present at or near the site under generation conditions that are differentiated according to recipient type, and provide the situation report text and the guidance text via at least one of a display interface and a sound output interface to corresponding client devices. This enables an integrated and computer-technical improvement in how multimodal emergency scene data are synchronized, analyzed, and translated into context-aware, role-specific announcements, thereby reducing processing latency and bandwidth usage, increasing robustness and accuracy of hazard assessment, and achieving reproducible and controllable use of a generative AI model through systematically constructed prompt sentences.

The term “system” refers to an overall combination of hardware and software components including at least one server and at least one information processing device, configured to perform data acquisition, communication, analysis, and information provision related to an accident, incident, or disaster site.

The term “server” refers to an information processing apparatus including at least one processor, a memory, and a communication interface, which is configured to receive, decrypt, decode, analyze, and process multimodal data from information processing devices and to generate and provide text and audio information.

The term “processor” refers to a hardware processing unit, such as a central processing unit or a graphics processing unit, or a combination thereof, configured to execute instructions stored in a memory to perform arithmetic operations, logical operations, control operations, and data input/output operations.

The term “memory” refers to a hardware storage device or storage subsystem, such as a semiconductor memory or a magnetic storage device, configured to store programs, parameters, models, and data used by the processor.

The term “communication interface” refers to a hardware and software interface configured to send and receive data to and from external devices via a wired or wireless communication network using one or more communication protocols.

The term “information processing device” refers to a portable or wearable electronic device, such as smart glasses, a smart terminal, or a mobile computing device, which is worn or carried by a human and includes at least an imaging function, a sound acquisition function, a position information acquisition function, a posture information acquisition function, a communication function, and a presentation function.

The term “imaging function” refers to a hardware and software function that uses an imaging element, such as a solid-state image sensor, to capture still images or moving images representing a surrounding scene and to output corresponding image information.

The term “sound acquisition function” refers to a hardware and software function that uses a sound sensor, such as a microphone, to capture audio signals representing sound in an environment and to output corresponding audio information.

The term “position information acquisition function” refers to a hardware and software function that uses a positioning module, such as a satellite positioning receiver or a network-based positioning device, to obtain geographic coordinates or other position-related data of the information processing device.

The term “posture information acquisition function” refers to a hardware and software function that uses one or more motion sensors, such as an accelerometer and a gyroscope, to obtain information indicating orientation, acceleration, angular velocity, or movement of the information processing device.

The term “image information” refers to digital data representing one or more images or frames obtained by the imaging function, including pixel values or encoded representations thereof.

The term “audio information” refers to digital data representing one or more audio signals obtained by the sound acquisition function, including sampled waveforms or encoded representations thereof.

The term “position information” refers to data indicating a location of the information processing device, including at least coordinate values and associated time information.

The term “posture information” refers to data indicating a motion or orientation state of the information processing device, including at least acceleration values, angular velocity values, and associated time information.

The term “time-series data” refers to a sequence of data elements of a certain type, such as image information or audio information, each element of which is associated with time information and arranged in chronological order.

The term “synchronized time-series data” refers to multiple types of time-series data, including at least image information, audio information, position information, and posture information, that are mutually associated using common or comparable time information such that data elements from different modalities correspond to overlapping or related time intervals.

The term “compression processing” refers to a data processing operation that reduces a size of data, such as image information or audio information, using a lossy or lossless encoding scheme to improve storage or transmission efficiency.

The term “encryption processing” refers to a data processing operation that transforms plaintext data into ciphertext using a cryptographic algorithm and a cryptographic key to provide confidentiality and integrity protection during storage or transmission.

The term “transmission data” refers to a data structure or packet that includes compressed and encrypted image information, audio information, position information, posture information, or metadata, which is prepared for sending over a communication network.

The term “analysis image information” refers to image information after decoding and any necessary pre-processing that is suitable as input to image analysis or recognition algorithms. The term “analysis audio information” refers to audio information after decoding and any necessary pre-processing that is suitable as input to speech recognition or acoustic analysis algorithms.

The term “analysis data set” refers to a structured set of data including analysis image information, analysis audio information, position information, posture information, and associated identifiers or indices, prepared for multimodal analysis.

The term “image recognition processing” refers to a computation that uses an image analysis algorithm or a learned model to detect, classify, or localize objects or regions of interest within analysis image information.

The term “physical objects” refers to entities present at or near a site, such as persons, vehicles, buildings, flames, smoke, or other tangible items that can be identified in image information.

The term “movement states” refers to attributes of physical objects concerning motion, such as speed, direction, trajectory, or change between standing and lying positions, derived from time-series image information or associated data.

The term “speech recognition processing” refers to a computation that converts analysis audio information into a character string or text sequence representing spoken words or utterances.

The term “acoustic analysis processing” refers to a computation that uses audio features extracted from analysis audio information to classify or detect acoustic events, such as screams, alarm sounds, or background noise states.

The term “conversation content” refers to textual information representing recognized words, phrases, or sentences obtained from speech recognition processing.

The term “important words” refers to words or expressions, such as emergency-related terms, that are selected based on predetermined criteria to indicate urgency, danger, or relevance in the conversation content.

The term “acoustic events” refers to categorized types of sounds detected in audio information, such as screams, shouts, crying, alarms, normal conversation, or silence.

The term “emotional states” refers to psychological conditions of humans, such as fear, anger, sadness, joy, surprise, calmness, or tension, inferred from one or more modalities including image, audio, and posture.

The term “facial analysis processing” refers to a sequence of image processing operations including at least detection of a face region in analysis image information and classification of an expression of the face region into one or more emotion categories.

The term “acoustic emotion analysis processing” refers to a sequence of audio processing operations that extracts audio features and classifies emotional categories of speech or sounds based on such features.

The term “text emotion analysis processing” refers to a sequence of text processing operations that uses natural language processing to classify emotional categories based on character strings obtained by speech recognition processing.

The term “posture analysis processing” refers to a sequence of processing operations applied to posture information to derive an index or measure related to body movement, agitation, or physical tension.

The term “emotion index” refers to a numerical or scalar value representing a unified or fused assessment of an emotional state of a human, calculated from at least facial analysis, acoustic emotion analysis, text emotion analysis, and posture analysis.

The term “physical hazard level” refers to a quantitative indicator that reflects a degree of physical danger at a site, derived from information relating to physical objects and their movement states, such as number of damaged objects, presence of fire, or apparent casualties.

The term “subjective tension level” refers to a quantitative indicator that reflects an apparent urgency or tension derived from speech and acoustic events, including frequency of important words and density of high-urgency sounds.

The term “psychological tension level” refers to a quantitative indicator that reflects a degree of emotional stress or anxiety among humans at or near a site, derived from emotion indices or related measures.

The term “comprehensive hazard index” refers to a unified quantitative indicator obtained by integrating the physical hazard level, the subjective tension level, and the psychological tension level, and representing an overall hazard or tension state at a site.

The term “crowd tension level” refers to a quantitative indicator representing a psychological or emotional state of a group of humans within a same area, computed by aggregating emotion indices of multiple humans.

The term “condition information” refers to structured information including at least information relating to physical objects, information relating to acoustic events, information relating to emotional states, and the comprehensive hazard index, used as a basis for text generation.

The term “prompt sentence” refers to a natural language instruction sentence or input text that encodes condition information and generation conditions and is provided to a generative AI model to control or guide generation of output text.

The term “generative AI model” refers to a learned information processing model, such as a large language model, that generates new text data or related information based on input text or structured data, including at least models trained using machine learning techniques.

The term “situation report text” refers to text data generated by the generative AI model for organizations involved in emergency response, including at least information about a site position, a physical damage situation, an estimated number of injured persons, a risk of secondary damage, and a required response scale.

The term “guidance text” refers to text data generated by the generative AI model for humans at or near a site, including at least reassurance content and recommended actions corresponding to emotional states of the humans and a safety level of the site.

The term “display interface” refers to a hardware and software interface configured to present visual information, such as text or graphics, to a user via a display device.

The term “sound output interface” refers to a hardware and software interface configured to output sound, such as voice guidance or synthesized speech, via a loudspeaker, headphone, or other audio output device.

The term “speech synthesis processing” refers to a processing operation that converts text data into sound data representing synthetic speech, using a text-to-speech engine or similar technology.

The term “client device” refers to an information processing device, including at least an information processing device worn or carried by a human or a device used by an organization, that receives and presents the situation report text, guidance text, or sound data provided by the server.

In the following embodiments, a server, a terminal, and a user cooperate to implement the claimed invention. Each embodiment is provided as an example and does not limit the scope of the claims. The same reference concepts are used for clarity across the embodiments.

### A. Overall System Architecture

The server is an information processing apparatus including at least one general-purpose processor such as a central processing unit, at least one graphics processing unit, a main memory, a nonvolatile storage device, and a communication interface. The server executes an operating system such as a server-class operating system and runs application software implemented, for example, in a high-level language. The server stores, in the nonvolatile storage device, a web application framework, a media processing library, a cryptographic library, a database management system, an object detection model implemented on a neural network framework, an automatic speech recognition engine, acoustic feature extraction libraries, emotion recognition models, and a generative AI model implemented as a large language model.

The terminal is an information processing device worn or carried by the user, such as smart glasses or a wearable computing device. The terminal includes at least an imaging sensor, a microphone, a positioning module, an inertial measurement unit including an accelerometer and a gyroscope, a display unit, an audio output unit, a wireless communication module, a processor, and a memory. The terminal runs a mobile operating system and executes a dedicated application implemented in a high-level programming language. The terminal application controls access to the imaging function, sound acquisition function, position information acquisition function, and posture information acquisition function via system-provided interfaces.

The user is a human who wears or carries the terminal at or near an accident, incident, or disaster site and becomes a source of multimodal data and a recipient of guidance text and audio.

### B. Multimodal Data Acquisition and Structuring

The terminal acquires image information, audio information, position information, and posture information in a coordinated manner using hardware and software components of the device.

The terminal uses the imaging sensor via an imaging application programming interface to capture image frames at a predetermined frame rate. The terminal associates each frame with a timestamp obtained from a device clock. The terminal stores the frames temporarily in a frame buffer in the memory.

The terminal uses the microphone via an audio acquisition interface to record audio samples at a predetermined sampling rate, such as 16 kHz, and resolution, such as 16 bits per sample.

The terminal segments a continuous audio stream into blocks of a fixed time length and associates each block with a timestamp.

The terminal uses the positioning module via a position information interface to obtain geographic coordinates at periodic intervals. The terminal associates each set of coordinates with a timestamp and stores the data in a location buffer. Similarly, the terminal uses the accelerometer and gyroscope via a sensor management interface to obtain posture information as time-stamped three-axis acceleration values and three-axis angular velocity values and stores these values in a posture buffer.

The terminal associates image information, audio information, position information, and posture information using a common time base. The terminal defines time windows of predetermined length and, for each time window, selects image frames, audio blocks, the nearest location record, and posture records that fall within the time window. The terminal generates a multimodal data structure that includes references to the image frames and audio blocks and embedded position and posture information for the time window. By structuring the data in this manner at the terminal, the system reduces the need for complex synchronization at the server and enables the server to use compact, pre-aligned data blocks.

The terminal performs compression processing on the data blocks by encoding image frames into a video stream, such as using a block-based transform codec, and encoding audio blocks into an audio stream, such as using a psychoacoustic-based codec. The terminal serializes metadata including position information, posture information, a device identifier, and timing information into a structured text format such as a hierarchical key-value representation. The terminal then aggregates the compressed media streams and metadata into a container, such as a binary packet with defined sections and offsets.

The terminal performs encryption processing on the container by using a symmetric-key encryption algorithm in an authenticated encryption mode. The terminal generates a random initialization vector and computes ciphertext and an authentication tag. The terminal transmits the resulting encrypted data to the server via a wireless communication network, using a secure transport protocol that provides additional encryption and integrity protections. By compressing and encrypting the data at the terminal, the system reduces network bandwidth usage and protects the privacy and integrity of the transmitted data, thereby contributing to improved technical performance in the communication subsystem.

### C. Server-Side Decryption, Decoding, and Database Structuring

The server receives encrypted transmission data via the communication interface. The server terminates the transport encryption, parses the encrypted payload, and performs decryption processing using the stored cryptographic key and algorithm to obtain the original container.

The server extracts the compressed image stream, compressed audio stream, and metadata.

The server uses a media processing library to decode the compressed image stream into analysis image information, which may be represented as arrays of pixel values in a standard color space. The server also decodes the compressed audio stream into analysis audio information, which may be represented as arrays of audio samples. The server parses the metadata to reconstruct position information and posture information as time-series data.

The server associates the analysis image information and analysis audio information with the position information and posture information by referencing time indices. The server generates structured records in a persistent storage system, such as a relational database, such that each record includes identifiers for image frames and audio clips, associated position and posture records, and any intermediate analysis results. The server may also store the raw or decoded media data in an object storage subsystem and record pointers or keys in the database.

By structuring the data into synchronized, indexed records, the server enables efficient queries that retrieve all relevant modalities for a particular time and location, reduces redundant storage of overlapping segments, and improves cache locality during later analysis. These technical effects contribute to improvements in data management and computing efficiency beyond a mere automation of human review.

### D. Image Recognition and Movement State Estimation

The server executes image recognition processing on the analysis image information. In one embodiment, the server uses a neural network framework to load an object detection model.

The model may be a convolutional neural network including multiple convolution layers, normalization layers, nonlinear activation layers, and pooling layers, followed by detection heads that output bounding boxes and class scores. The model may be trained in advance using annotated images of persons, vehicles, buildings, flames, smoke, and other physical objects.

The server preprocesses each image frame by resizing, normalizing pixel values, and rearranging the array layout into a tensor suitable for the neural network. The server applies a forward pass through the object detection model on a graphics processing unit to accelerate computation. The server obtains, for each frame, a set of candidate bounding boxes with associated class probabilities and confidence scores. The server applies non-maximum suppression and a confidence threshold to filter out low-confidence detections.

The server estimates movement states by correlating detections across multiple frames. The server uses a tracking algorithm that maintains a state vector for each physical object, including position and velocity, and updates the state using a prediction step and a correction step. The server solves a data association problem to match current detections to existing tracks. From the estimated trajectories, the server determines whether a vehicle is moving, stopped, or has undergone a sudden change in velocity and whether a person is standing, walking, or lying on a surface.

This combination of neural network-based detection and model-based tracking provides higher detection accuracy and more stable movement estimation than simpler frame-by-frame thresholding or manual inspection, thereby improving the technical capability of the server to analyze dynamic scenes in real time.

### E. Speech Recognition, Acoustic Event Detection, and Text Analysis

The server executes speech recognition processing on the analysis audio information. The server uses an automatic speech recognition engine based on a neural encoder-decoder architecture. The engine includes a feature extractor that converts raw audio samples into spectrograms or other time-frequency features, followed by an encoder that processes the features into a sequence of hidden representations and a decoder that generates text tokens representing recognized speech. The model is trained beforehand on large corpora of speech and text pairs.

The server feeds audio clips into the speech recognition engine, obtains tokens, and concatenates the tokens into text strings representing conversation content. The server associates the text segments with the corresponding time intervals and stores them in the database.

The server performs acoustic analysis processing by computing audio features and classifying acoustic events. The server applies a feature extraction algorithm to compute, for each audio segment, energy-related and spectral features. The server feeds these features into an acoustic classifier, which may be a neural network or another machine learning model trained to output labels such as scream, alarm, normal conversation, or silence. The server records these labels and confidence scores as acoustic events.

The server performs natural language processing on the recognized text to extract important words and to evaluate text-based emotional expressions. The server uses a tokenizer to split the text into language-specific word units and compares tokens with a stored dictionary of emergency-related terms. The server also uses a text emotion classifier implemented as a transformer-based neural network. The classifier receives tokenized text encoded into vector representations and outputs a probability distribution over emotion categories such as fear, anger, sadness, joy, and neutral. The server stores these distributions and selected labels. By using neural architectures adapted to continuous speech and by extracting structured representations of both linguistic content and paralinguistic acoustic events, the server achieves improved recognition accuracy and robustness in noisy environments compared to simpler keyword spotting or amplitude thresholding approaches. This contributes to an improvement in computer-based speech and audio processing technology.

### F. Multimodal Emotion Estimation

The server estimates emotional states of humans present at the site by performing facial analysis processing, acoustic emotion analysis processing, text emotion analysis processing, and posture analysis processing and then fusing the results.

The server performs facial analysis processing by detecting faces in image frames, extracting face patches, and feeding the patches into a facial expression classification network. The network may be a convolutional neural network with residual connections trained on face images labeled with emotion categories. The network outputs, for each face patch, a vector of scores representing the likelihood of different emotional expressions.

The server performs acoustic emotion analysis processing by feeding spectrograms or learned audio embeddings of speech segments into a classifier. The classifier may be a recurrent or transformer-based model that learns temporal patterns associated with voice-based emotions.

The classifier outputs emotion scores corresponding to categories similar to those used in the facial analysis.

The server performs text emotion analysis processing using the transformer-based classifier described above to obtain textual emotion scores. The server performs posture analysis processing by analyzing time-series acceleration and angular velocity data. The server computes derived metrics such as variance, number of abrupt changes, and frequency-domain energy in specific bands, and uses these metrics as features. The server either applies a rule set or a trained model to estimate a body tension measure.

The server fuses the outputs of these analyses into an emotion index for each human. In one embodiment, the server constructs a feature vector that concatenates the facial emotion probabilities, acoustic emotion probabilities, text emotion probabilities, and body tension features. The server uses a fusion model implemented as a fully connected neural network with one or more hidden layers. The network is trained with a supervised learning method on labeled multimodal emotion data. During training, the server or a separate training environment minimizes a loss function such as cross-entropy or mean squared error between the network output and ground truth emotional labels. The training process updates the weights of the network using a gradient-based optimization algorithm. The server may use data augmentation in the training phase, such as adding noise to audio or applying geometric transformations to face patches, to improve generalization.

At inference time, the server executes the trained fusion model to output an emotion index, for example a scalar between 0 and 1, representing the intensity of negative emotion or stress.

The server aggregates indices across time and users to compute a crowd tension level, such as by averaging indices or computing the proportion of indices above a threshold.

This multimodal fusion approach is not a mere automation of human observation but provides a non-intuitive, algorithmically optimized way to combine heterogeneous signals, thereby improving the precision and stability of crowd emotion estimation and enabling the server to handle large numbers of users in real time with bounded computational costs.

### G. Hazard Scoring and Prompt Sentence Construction

The server calculates a physical hazard level, a subjective tension level, and a psychological tension level based on analysis outputs, and then calculates a comprehensive hazard index.

The server uses a stored rule set or a learned regression model to map features to scores. Features for the physical hazard level may include the number and types of physical objects, presence of flames or smoke, and durations of detected casualties. Features for the subjective tension level may include frequencies of important words and counts of high-urgency acoustic events. Features for the psychological tension level may include average emotion indices and the crowd tension level.

The server normalizes and scales these feature values using learned or predetermined parameters and combines them using a weighted sum or a more complex mapping. The server may store configuration values for these weights and allow adjustment to adapt to different deployment environments. The server outputs a comprehensive hazard index as a scalar in a defined range.

The server constructs at least one prompt sentence for a generative AI model. The server builds the prompt sentence as a natural language instruction that describes the server-assessed situation and specifies generation requirements. The server uses programmatic string concatenation and templates to embed condition information, such as physical hazard summaries, acoustic event summaries, emotional summaries, and the comprehensive hazard index, into a human-readable, loggable text format. This structured prompt design has technical advantages over ad-hoc free-form prompts by enabling deterministic reconstruction and audit, reducing failure modes in the generative process, and simplifying downstream filtering of model outputs.

For example, the server may construct the following prompt sentence for responder organizations:

“You are an operator reporting the situation to the emergency response headquarters. Based on the following information, generate a situation report in plain style for firefighters, police officers, and paramedics.
Scene location: near XX intersection, XX district
Physical situation: 3 vehicles involved in a collision (2 of them heavily damaged), flames and thick smoke detected, 2 persons found lying on the ground
Audio keywords: ‘help’, ‘fire’, and ‘about to explode’ occur frequently
Crowd panic level: high (many users have an emotion index of 0.8 or higher)
Comprehensive hazard index: 8/10

Taking the above into account, generate a report that includes the scale of the accident, the estimated number of injured persons, the risk of secondary disasters, the necessary response units, and the need for crowd control.”

As another example, the server may construct the following prompt sentence for a user:

“You are a system that calms citizens during disasters and guides them to safe behavior. Based on the following information, generate a guidance message in plain style for the user wearing the terminal.
User location: on the sidewalk about 70 meters away from the accident scene, inside a safe area
Scene situation: collision of 3 vehicles and a small-scale fire detected. Flames are being brought under control by the fire department
User emotional state: high fear level (emotion index 0.85)
Recommended action: stay where you are and watch for nearby vehicle movements Generate a Japanese message of about 30-50 characters in a calm tone to reassure the user.” The server uses different templates and condition sets for different recipient types, thereby enabling an explicit separation of roles and generation behaviors within the generative AI model.

### H. Generative AI Model Execution and Speech Synthesis

The server executes a generative AI model implemented as a large language model on a neural network framework. The model includes an embedding layer, multiple transformer blocks with attention mechanisms, and an output projection layer to a token vocabulary. The model is pre-trained on large general-purpose corpora and may be fine-tuned using domain-specific instructions and responses.

The server feeds the constructed prompt sentence into the model, tokenizes the text, and executes successive forward passes to generate tokens for an output sequence. The server controls decoding behavior using parameters such as maximum length, temperature, and nucleus sampling or beam search settings. The server collects the generated tokens and converts them back into a character string representing the situation report text or guidance text.

The server may apply post-processing, such as truncation or filtering of inappropriate content, to ensure that the output conforms to pre-defined policies. By combining a structured prompt sentence with a trained generative model, the server can produce high-quality, contextually appropriate text without requiring manual template authoring for every possible situation, thereby improving the efficiency and flexibility of information generation.

The server converts the guidance text into sound data using a speech synthesis engine. The engine may be implemented as a neural network with an encoder-decoder architecture that converts sequences of characters or phonemes into mel-spectrograms and a separate neural vocoder that converts mel-spectrograms into audio waveforms. The server feeds the guidance text to the encoder, obtains the spectrogram, feeds the spectrogram to the vocoder, and obtains time-domain samples. The server encodes the samples into a compressed audio format suitable for streaming to the terminal.

### I. Information Provision and Technical Effects

The server sends the situation report text, guidance text, and associated metadata to client devices via the communication interface. For responder organizations, the server exposes a network endpoint that returns machine-readable structures including the text and hazard scores. For the user, the server sends the guidance text and synthesized audio to the terminal.

The terminal receives the guidance text and sound data, displays the text on the display unit in an overlay format, and plays the sound via the audio output unit. The user can follow the instructions without needing to interact with a complex user interface. Because the server maintains a continuous loop of data acquisition, analysis, hazard evaluation, and text generation, the system adapts dynamically to changes in the physical and emotional situation in near real time.

The described architecture improves computer technology in several ways. The multimodal synchronization at the terminal reduces server-side alignment costs and avoids duplicate processing. The database structuring and indexing for analysis data sets improve retrieval efficiency and caching behavior. The neural network models for detection, recognition, and emotion fusion provide higher accuracy and robustness than rule-only methods. The hazard scoring pipeline and structured prompt construction transform raw sensor data into compact summary parameters and instruction sentences that drive the generative AI model in a reproducible, controlled manner, thereby reducing the computational effort required to generate context-appropriate text.

In particular, the server reduces network bandwidth by compressing and batching data, reduces latency by executing inference on a graphics processing unit and by working with pre-structured data sets, and reduces errors by using multimodal fusion to mitigate weaknesses of any single modality. The integrated architecture and non-conventional combination of multimodal fusion with prompt-based generative modeling yield a new computer-centric solution that could not be achieved by manual human judgment or by simple automation of human tasks. The system as implemented controls concrete hardware devices, including the terminal's sensors and presentation units, and operates on physical-world data in real time to produce technical improvements in data handling, analysis, and communication under emergency conditions.

### J. Variations and Alternative Embodiments

The server may use alternative implementations without departing from the claims. For example, the object detection model may be replaced by a transformer-based vision model, the speech recognition engine may be replaced by a different neural architecture, and the multimodal fusion model may use attention mechanisms rather than simple concatenation.

The hazard scoring module may use a gradient-boosted decision tree model trained on historical incidents instead of fixed-weight linear combinations.

The terminal may be implemented as a smartphone with an attached head-mounted display rather than integrated smart glasses, or as another type of wearable device that still provides the claimed acquisition functions. The communication interface may use different transport protocols and may apply adaptive bitrate control. The generative AI model may be executed on a separate cloud service under control of the server, with the server responsible for constructing and logging prompt sentences and for validating outputs.

In all such embodiments, the server remains configured to acquire synchronized multimodal data, execute multimodal analysis including emotion estimation, compute a comprehensive hazard index, construct prompt sentences that encode quantitative and qualitative conditions, and drive a generative AI model to produce differentiated situation report text and guidance text, and to provide these outputs to appropriate recipients via specific hardware interfaces.

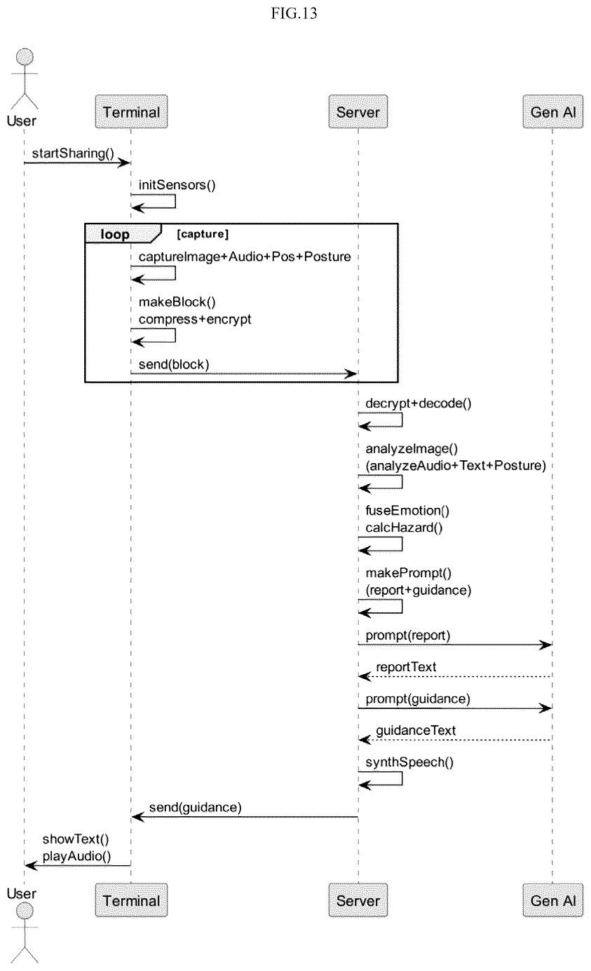

The following describes the processing flow using FIG. 13.

### Step 1:

The user wears the terminal and starts data sharing.

The user operates the terminal's user interface to launch the dedicated application and explicitly approves data collection. As input, the terminal receives user interactions such as touch events or gaze selections. The terminal processes these inputs by updating an internal state flag indicating that data sharing is enabled and by recording a consent log with a timestamp as output.

### Step 2:

The terminal initializes sensor access and permissions.

The terminal uses the operating system's permission APIs to check access rights for the camera, microphone, location module, and motion sensors. As input, the terminal uses a list of required permissions. The terminal compares this list against current permission states, requests missing permissions via system dialogs, and, if granted, opens handles to the camera, microphone, GPS, accelerometer, and gyroscope. As output, the terminal produces initialized sensor interfaces and an internal state indicating that sensor acquisition threads can start.

### Step 3:

The terminal acquires time-stamped image information.

The terminal drives the imaging sensor using an imaging API and receives raw frames as input from the hardware. For each frame, the terminal reads a current time value from a system clock, attaches the timestamp to the frame data, and pushes a frame object into a video buffer. As output, the terminal maintains a time-ordered sequence of image frames, each containing pixel data and a timestamp.

### Step 4:

The terminal acquires time-stamped audio information.

The terminal configures the microphone via an audio recording interface and receives raw audio samples as input from the hardware. The terminal groups samples into fixed-length blocks, such as one-second segments, and associates each block with a timestamp from the system clock. The terminal enqueues these blocks into an audio buffer. As output, the terminal maintains a time-ordered sequence of audio segments, each containing waveform data and a timestamp.

### Step 5:

The terminal acquires position information.

The terminal registers for position updates from the positioning module via a location API and receives coordinate readings as input, including latitude, longitude, and acquisition time.

The terminal stores each reading as a position record with explicit time information. As output, the terminal maintains a time-ordered list of position records that can later be aligned with image and audio data.

### Step 6:

The terminal acquires posture information.

The terminal registers listeners for the accelerometer and gyroscope via a sensor management interface and receives sensor events as input, each containing acceleration values, angular velocity values, and sensor timestamps. The terminal normalizes or scales raw sensor values if necessary and writes them into a posture buffer as posture records. As output, the terminal maintains a time-series of posture information that reflects orientation and movement of the terminal.

### Step 7:

The terminal associates multimodal data into synchronized blocks.

The terminal takes, as input, the buffered sequences of time-stamped image frames, audio segments, position records, and posture records. The terminal defines a time window, such as a two-second interval, and for each window selects all frames and segments whose timestamps fall within the interval or overlap it. The terminal identifies the closest position record in time to the center of the window and collects all posture records in the window. The terminal then constructs a multimodal block object that contains references to image frames, audio segments, and embedded position and posture information. As output, the terminal produces a stream of multimodal blocks that are aligned across modalities.

### Step 8:

The terminal compresses media data within each multimodal block.

The terminal receives a multimodal block as input and extracts raw image frames and audio segments. The terminal passes the image frames to a video encoder that performs transform coding and motion estimation to produce a compressed video bitstream. The terminal passes the audio segments to an audio encoder that performs psychoacoustic analysis and quantization to produce a compressed audio bitstream. The terminal thus reduces data size while preserving essential information. As output, the terminal generates a compressed media bundle containing a video stream and an audio stream for each time window.

### Step 9:

The terminal packs metadata with compressed media.

The terminal uses, as input, the compressed media bundle and corresponding position and posture information. The terminal serializes metadata, including position coordinates, posture summaries, device identifiers, and time ranges, into a structured format. The terminal then assembles a container by combining the serialized metadata and compressed media, arranging fields according to a defined packet structure. As output, the terminal obtains a self-contained container object that encapsulates all data needed for server-side analysis for that time window.

### Step 10:

The terminal encrypts the container for secure transmission.

The terminal takes the container bytes as input and retrieves or derives a session key for symmetric encryption. The terminal generates a random initialization vector, applies an authenticated encryption algorithm to compute ciphertext and an authentication tag, and wraps algorithm identifiers, the initialization vector, the ciphertext, and the tag into an encrypted packet. As output, the terminal produces an encrypted data packet prepared for transmission over an untrusted network.

### Step 11:

The terminal transmits encrypted packets to the server.

The terminal reads encrypted packets from a send queue as input and opens an outgoing secure connection to the server using a network library. The terminal writes the packet data as the body of a secure request, appends headers such as device identifiers and protocol versions, and monitors acknowledgments and error codes. The terminal may adjust packet frequency or media compression parameters based on observed network throughput. As output, the terminal forwards encrypted packets to the server and logs transmission results.

### Step 12:

The server receives and decrypts transmission data.

The server accepts incoming network requests and extracts encrypted payloads as input from the communication interface. The server verifies transport-layer security, parses the payload structure to obtain algorithm identifiers, initialization vector, ciphertext, and authentication tag, and calls a cryptographic routine to perform decryption and integrity verification. As output, the server reconstructs the original container, which includes compressed image and audio streams and metadata.

### Step 13:

The server decodes media data and rebuilds time-series structures.

The server takes the compressed video and audio streams and metadata as input. The server uses a media decoding library to decompress the video stream into analysis image information, such as sequences of decoded frames, and to decompress the audio stream into analysis audio information, such as sequences of sample arrays. The server parses the metadata to reconstruct position and posture records with timestamps. The server associates decoded frames and audio segments with corresponding records based on time alignment. As output, the server obtains a synchronized analysis data set per container that includes analysis image information, analysis audio information, position information, and posture information.

### Step 14:

The server performs image recognition to identify physical objects.

The server reads analysis image information as input and applies preprocessing operations such as resizing, normalization, and conversion to tensor form. The server passes the tensors through an object detection model implemented on a neural network framework, which performs convolutional operations and outputs bounding boxes and class probabilities. The server filters detections based on confidence scores and labels each detection with a category, such as person, vehicle, or flame. As output, the server generates a set of physical object records for each frame, including positions, sizes, object types, and confidence values.

### Step 15:

The server estimates movement states of physical objects.

The server uses time-sequenced physical object records as input and groups records by object identity using a tracking algorithm. The server initializes and updates state vectors that include position and velocity components for each object and uses prediction and correction steps to track motion over frames. The server computes derived quantities, such as speed and trajectory direction, and determines state changes, such as a transition from moving to stationary or from upright to lying down. As output, the server produces movement state descriptors for each identified object over time.

### Step 16:

The server executes speech recognition on audio segments.

The server takes analysis audio information as input and segments it into units of suitable length for processing. The server computes time-frequency representations, such as spectrograms, and inputs them into an automatic speech recognition model. The model computes hidden representations and outputs token sequences that correspond to recognized words. The server concatenates tokens and maps them back to characters or words to form conversation content. As output, the server obtains text segments with associated time intervals representing what was spoken near the terminal.

### Step 17:

The server detects acoustic events and extracts audio features.

The server uses audio segments as input and computes acoustic features such as energy and spectral descriptors with a feature extraction algorithm. The server feeds these features into an acoustic classification model that outputs event labels like scream, alarm, or normal conversation. The server also counts the number of occurrences of each event type within a time window. As output, the server generates acoustic event records, each containing an event label, confidence score, and associated time interval.

### Step 18:

The server extracts important words and evaluates text-based emotions.

The server takes recognized text segments as input and tokenizes them into language units.

The server compares tokens against a stored list of important words related to emergencies and increments counters when matches occur. The server also feeds tokenized text into a text emotion classifier, which computes attention-based representations and outputs probabilities for emotion categories such as fear or neutral. As output, the server produces a list of important word occurrences and a set of text emotion scores for each text segment.

### Step 19:

The server estimates visual and audio-based emotional states.

The server uses decoded image frames and audio segments as input. For images, the server detects face regions, crops them, and feeds them into a facial expression classifier, which outputs probabilities over emotion labels. For audio, the server computes embeddings or spectrograms and supplies them to an audio emotion classifier, which outputs probabilities of vocal emotions. The server associates these probability vectors with specific time intervals and, when possible, with specific users based on device identifiers or spatial proximity. As output, the server obtains facial emotion records and audio emotion records that describe per-modality emotional indications.

### Step 20:

The server analyzes posture information for body tension.

The server reads posture information as input and segments it according to time windows consistent with other modalities. The server computes statistics such as standard deviation of acceleration, count of rapid changes exceeding a threshold, and spectral energy in high-frequency bands. The server combines these statistics into a scalar body tension measure through a rule-based formula or simple model. As output, the server produces body tension records linked to specific users and time intervals.

### Step 21:

The server fuses multimodal emotion indicators into an emotion index.

The server takes facial emotion records, audio emotion records, text emotion scores, and body tension records as input. The server constructs feature vectors that align these different modalities for each user and time window by concatenating probability components and numeric measures. The server feeds these feature vectors into a fusion model that processes them through one or more dense layers and activation functions to produce a single scalar value between 0 and 1. As output, the server obtains an emotion index for each user at each time window, which represents overall emotional intensity.

### Step 22:

The server computes crowd tension and hazard levels.

The server uses per-user emotion indices along with physical object information, movement states, important word counts, and acoustic event statistics as input. The server groups users by geographic location and computes average emotion indices and the proportion of high emotion indices to derive a crowd tension level. The server computes a physical hazard level using physical object counts and states, and a subjective tension level using important words and acoustic event densities. The server combines these three values via a weighted formula or model to produce a comprehensive hazard index. As output, the server stores the crowd tension level, hazard levels, and comprehensive hazard index for the scene and time window.

### Step 23:

The server constructs prompt sentences for responder reports.

The server uses condition information, including scene location, physical hazard description, crowd tension level, and comprehensive hazard index, as input. The server formats this information into a natural language structure using string templates. The server includes role instructions and specifies output requirements to form a prompt sentence for a generative AI model. As output, the server generates a responder-oriented prompt sentence that encodes quantitative and qualitative scene conditions in text form.

### Step 24:

The server constructs prompt sentences for user guidance.

The server takes, as input, an individual user's position, emotion index, recommended action, and a summary of the scene situation. The server maps this information into a role-specific instruction template that instructs the generative AI model to produce a short, calming message. The server sets constraints such as desired message length and tone. As output, the server generates a user-oriented prompt sentence tailored to that user's context and emotional state.

### Step 25:

The server calls the generative AI model with the constructed prompt sentences.

The server feeds the responder-oriented and user-oriented prompt sentences as input to the generative AI model. The server tokenizes each prompt, runs the model's inference procedure to generate output tokens, and configures decoding parameters such as maximum length and temperature. The server converts output tokens to text strings representing situation report text and guidance text. As output, the server obtains generated texts that describe the scene for responders and provide instructions for users.

### Step 26:

The server converts guidance text into sound data.

The server uses the guidance text as input and passes tokenized or character-based representations to a speech synthesis engine. The server computes intermediate acoustic features, such as mel-spectrograms, and then converts them into waveform samples via a vocoder model. The server optionally compresses the waveform into an audio codec format. As output, the server produces sound data that encodes the guidance message as synthetic speech.

### Step 27:

The server distributes generated information to responders and users.

The server takes situation report text, guidance text, sound data, and hazard metrics as input and prepares response payloads for different client types. The server formats structured data for responder devices and includes the situation report text and hazard indicators. For the terminal, the server packages guidance text and sound data. The server sends these payloads over the communication interface to the appropriate devices. As output, the server delivers targeted information that can be immediately used by responder systems and by the terminal.

### Step 28:

The terminal presents guidance text and sound to the user.

The terminal receives, as input, the server's response containing guidance text and sound data.

The terminal parses the response, extracts the text and audio, and renders the text on the display unit as an overlay in the user's field of view. The terminal decodes the sound data if necessary and plays it through the audio output unit. As output, the terminal presents visual and auditory guidance to the user, enabling the user to understand the current situation and recommended actions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional incident-site information systems mainly focus on aggregating objective environment data, such as images and audio from cameras or microphones, and then generating fixed-format summaries or alerts. While such systems can improve the speed of situational awareness, they typically rely on rigid rule-based pipelines that are insensitive to the cognitive state or emotional state of human recipients and human data providers. As a result, conventional systems often generate announcements that are either too technical, too brief, or too detailed for the actual needs and stress level of responders and observers in the field.

From a computing-technology standpoint, existing pipelines process heterogeneous sensor data-video, audio, and location-argely in isolation. They generally lack an integrated architecture in which environment understanding and human emotion recognition are jointly modeled and jointly used to control downstream information generation. In particular, prior systems do not maintain a unified “integrated sensor information” structure annotated with synchronized time and position, on top of which both risk estimation and emotion estimation are computed in a coordinated manner. This separation leads to duplicated processing, inefficient use of computational resources, and limited adaptability of the generated output. Furthermore, conventional systems that do use machine learning for environment recognition typically terminate their processing with a fixed, manually coded text template. They do not exploit modern generative models to construct explanation texts that are dynamically adapted, in content and tone, to both the estimated risk level at the site and the estimated emotional state of human users. They also do not formalize the construction of prompt sentences as a programmable interface between sensor analytics and generative models. As a consequence, it is difficult to systematically control, at the system level, the length, vocabulary, and tone of explanations in response to changing risk indicators and emotion signals.

In addition, most known systems treat emotion-related signals, such as voice prosody, facial expressions, or biosignals, if at all, as secondary annotations rather than as first-class computational inputs to the explanation-generation pipeline. They lack a dedicated multimodal fusion stage that converts image features, acoustic features, and biosignal features into an explicit emotional state vector, and they do not feed such a vector back into the core logic that builds the prompt sentences for a generative model. This results in an underutilization of available data and a missed opportunity to tailor machine-generated communications to human users under stress.

Therefore, there is a need for an improved computer-implemented system that (i) constructs and maintains integrated sensor information combining environment and emotion-related data with time and position annotations, (ii) uses machine-learned models to compute both an objective risk degree and a structured emotional state vector, and (iii) programmatically generates prompt sentences supplied to a generative AI model so that natural-language outline explanations and scripts are dynamically adapted in length, terminology, and tone to the current context. Such a system would improve the underlying computing architecture for incident-site situational awareness by providing a flexible, data-driven interface between multi-sensor analytics and generative explanation models, thereby enhancing the relevance, clarity, and usability of the generated announcements.

The specific processing by the specific processing unit 290 of the data processing device 12 in Application Example 2 is realized by the following means.

The present invention provides a server comprising a processor and a memory storing instructions which, when executed by the processor, cause the processor to collect environment information including image information and audio information and emotion-related information including utterances and movements from at least one wearable display device located near an incident site, to associate the collected information with time information and position information, and to store the associated information as integrated sensor information; to apply at least one trained discrimination model and at least one state estimation algorithm to the integrated sensor information so as to identify object arrangements and moving object behaviors at the incident site and to compute a risk degree indicating a probability of occurrence of a hazardous event, and to apply at least one emotion recognition model to utterance content, acoustic features, expression information, and biological signals contained in the integrated sensor information so as to estimate an emotional state of an observer; to define site outline information, on a basis of the computed risk degree and the estimated emotional state, the site outline information including information relating to a position, a scale, a number of involved persons, and a danger level of the incident site and having an expression style and a level of detail corresponding to the emotional state; to generate a prompt sentence including the risk degree, the emotional state, and the site outline information, and to input the prompt sentence to a generative information processing model so as to generate a natural-language outline explanation text and a script for audio explanation; and to perform audio generation processing on a basis of the outline explanation text and the script for audio explanation and to provide the site outline information and a safety evaluation of the incident site to related persons. This enables a computing architecture in which multi-modal sensor data are unified into integrated sensor information, both risk estimation and emotion estimation are performed in a coordinated manner, and dynamically constructed prompt sentences bridge analytics and a generative AI model so that incident-site announcements are automatically tailored in content, length, and tone to the current risk degree and the emotional state of human users.

The term “environment information” refers to information representing a physical scene around an incident site, including at least image information captured by an imaging device and audio information captured by an audio input device.

The term “emotion-related information” refers to information used to estimate an emotional state of a human, including at least utterance content, acoustic characteristics of speech, body movements, facial expressions, and biological signals.

The term “wearable display device” refers to a wearable apparatus configured to be worn on a body part of a user and to present visual information to the user, the apparatus including at least one imaging device, at least one audio input device, and a communication interface.

The term “integrated sensor information” refers to a combined data structure in which environment information and emotion-related information obtained from one or more sensing devices are associated with common time information and position information and stored in a unified format.

The term “time information” refers to information indicating a time at which sensor data are acquired, including at least a timestamp or a time index generated by a time reference source.

The term “position information” refers to information indicating a geographical position or spatial location associated with sensor data, including at least coordinates, a location label, or data derived from a positioning system.

The term “trained discrimination model” refers to a computational model obtained by training a machine learning algorithm with training data so as to perform at least one of classification, detection, or recognition on input data such as images or audio signals.

The term “state estimation algorithm” refers to a computational procedure for estimating a state of an object or a system, including at least estimation of position, velocity, or trajectory over time, based on observed data and a dynamic model.

The term “risk degree” refers to an index indicating a probability or severity of occurrence of a hazardous event at an incident site, computed from environment information, including at least a numerical score or a categorical level.

The term “emotion recognition model” refers to a computational model configured to estimate an emotional state of a human by receiving as input at least one of utterance content, acoustic features, expression information, and biological signals and outputting values corresponding to emotion categories or emotion intensities.

The term “emotional state” refers to information representing a psychological condition of a human, including at least a degree of anxiety, tension, comfort, or calmness, expressed as one or more scalar values or a vector.

The term “site outline information” refers to structured information summarizing a situation at an incident site, including at least information relating to a position, a scale, a number of involved persons, a danger level, and optionally recommended response policies.

The term “expression style” refers to a set of characteristics of a natural-language expression, including at least politeness level, directness, technicality, and emotional tone, that control how information is presented to a human.

The term “level of detail” refers to a degree of granularity of information included in an explanation, including at least an amount of descriptive content, a number of items listed, or a depth of technical description.

The term “prompt sentence” refers to a natural-language instruction text or query text supplied as input to a generative information processing model, the text specifying at least a target situation, constraints on output format, and a desired tone of the generated output.

The term “generative information processing model” refers to a computational model configured to generate new natural-language text or similar content in response to an input prompt sentence, based on statistical patterns learned from training data.

The term “outline explanation text” refers to a natural-language text generated by a generative information processing model that describes, in summarized form, the site outline information and related safety evaluation.

The term “script for audio explanation” refers to a natural-language text tailored for conversion into synthesized speech, including at least phrasing and sentence segmentation suitable for oral presentation.

The term “audio generation processing” refers to processing that converts a natural-language text, including at least an outline explanation text or a script for audio explanation, into an audio signal by using speech synthesis or a related technique.

The term “related persons” refers to human users who receive information about an incident site, including at least on-site responders, remote operators, supervisors, or observers requiring situational awareness.

The term “prompt sentence template” refers to a parameterized text pattern stored in a memory, the pattern including placeholders for numerical indicators, contextual conditions, and outline information, and configured to be instantiated as a concrete prompt sentence by inserting specific values.

The term “numerical indicators representing the risk degree and the emotional state” refers to numeric values, such as scalar scores or vector components, that quantitatively express at least a computed risk degree and an estimated emotional state.

The term “surrounding environment situation” refers to contextual conditions around an incident site, including at least presence and arrangement of objects, movement of persons or vehicles, and environmental factors influencing risk.

The term “response policy” refers to abstract information specifying a recommended course of action or handling strategy for an incident, including at least priority levels, caution requirements, or coordination guidelines.

The term “tone required for an explanation” refers to constraints on style of expression in generated text, including at least whether the expression should be formal or informal, calm or urgent, and reassuring or strictly informative.

The term “expression images” refers to images containing at least a face or body of a human and usable to extract features related to facial expressions or body posture.

The term “audio signals” refers to time-varying digital or analog signals representing sound, including at least speech produced by a human user.

The term “biological signals” refers to time-series data acquired from a human body, including at least heart rate, heart rate variability, respiratory rate, or other physiological measurements.

The term “biological information acquisition device” refers to a device configured to measure biological signals of a human, including at least a sensor integrated into equipment or a wearable sensor communicatively coupled to the system.

The term “image feature extraction processing” refers to computational operations that transform image data into numerical feature representations suitable for input to a model, including at least extraction of facial landmarks, texture descriptors, or deep feature vectors.

The term “acoustic feature extraction processing” refers to computational operations that transform audio signals into numerical feature representations suitable for input to a model, including at least spectral, cepstral, or prosodic features.

The term “biological signal analysis processing” refers to computational operations that transform raw biological signals into descriptors of physiological state, including at least time-domain, frequency-domain, or model-based analyses.

The term “multimodal integration model” refers to a computational model configured to receive, as input, feature representations from a plurality of modalities, including at least image, audio, and biological signals, and to output an integrated representation such as an emotional state vector.

The term “emotional state vector” refers to a multi-dimensional numerical representation of an emotional state, each dimension corresponding to a component such as anxiety level, tension level, or comfort level.

The term “technical terms” refers to words or phrases that are specific to a professional or specialized domain and that may not be easily understood by a general user without domain knowledge.

In one embodiment, terminal, server, and user cooperate to implement the claimed invention using concrete hardware and software components.

Terminal operates as a wearable-side or field-side device. Terminal includes at least one processor, a memory, an imaging device, an audio input device, a wireless communication interface, and optionally one or more biological signal sensors. Terminal, for example, is implemented as a wearable display device such as smart glasses with an integrated camera and microphone, or as a portable computing device connected to such a wearable apparatus. Terminal runs an embedded operating system such as a general-purpose operating system or a real-time operating system, and executes application software that controls the imaging device, acquires audio signals via an audio library such as a portable audio I/O library, and manages a wireless communication stack such as a short-range wireless protocol stack and an Internet protocol stack.

Terminal acquires environment information and emotion-related information in a manner that reduces communication bandwidth and improves synchronization accuracy. Terminal attaches timestamps, for example using a local clock synchronized via network time synchronization, and position information, for example obtained via a positioning module or via network-based localization, to each captured image frame, each audio segment, and each biological signal record. Terminal aggregates these time- and position-tagged records into an integrated sensor information structure stored in memory. Terminal uses a structured data format, for example a record structure in which keys represent sensor modality and values represent arrays of modality-specific records, to unify heterogeneous data. This specific integrated data structure allows server to execute joint risk estimation and emotion estimation using shared time and position indices, which reduces redundant parsing and alignment operations and thereby improves overall processing speed and reduces memory consumption.

Server operates as a centralized computation apparatus. Server includes multiple processors, including at least one general-purpose central processor and optionally at least one graphics processor or tensor accelerator, a large-capacity memory, non-volatile storage, and a network interface. Server runs a server operating system and application processes that implement ingestion, perception, emotion estimation, prompt sentence construction, generative AI model invocation, and explanation distribution. Server receives integrated sensor information transmitted from terminal via a secure communication protocol such as a transport layer security protocol over an application protocol such as a hypertext transfer protocol or a remote procedure call protocol. Server decrypts and parses incoming packets and reconstructs the integrated sensor information as an in-memory object graph.

Server applies trained discrimination models to the environment information included in the integrated sensor information. Server, in one exemplary implementation, loads a convolutional neural network classifier or detector implemented using a deep learning framework such as a generic tensor computation framework. Server structures each image frame into a tensor of pixel intensities and normalizes the tensor according to predetermined mean and variance values. Server then performs convolution, activation, and pooling operations layer by layer, as defined by the neural network architecture, to extract feature maps and to output bounding boxes and class probabilities for objects such as persons, vehicles, and static structures. Server uses a loss function such as a combination of localization loss and classification loss during training and stores the trained weights in persistent storage. Server, during inference, uses only forward propagation and does not perform weight updates.

Server further applies a state estimation algorithm, for example a Kalman filter or an extended Kalman filter, to object positions and velocities derived from image-based detections and, optionally, from additional sensors if available. Server represents each tracked object by a state vector including at least position and velocity components and uses a dynamic model matrix and an observation model matrix to perform prediction and update calculations. Server propagates the covariance matrix of each state vector to maintain an uncertainty estimate. Using these predicted states, server computes the minimum predicted distance between the observer and each object over a time horizon and the probability of intersection within that horizon, and aggregates these values into a risk degree index. Server can define the risk degree as a scalar value or as a multi-dimensional vector, and can further categorize the risk degree into discrete levels such as low, medium, and high.

Server applies one or more emotion recognition models to emotion-related information in the integrated sensor information. Server, for facial expression analysis, uses an image processing library such as a general-purpose computer vision library to detect a face region and then resizes the region into an input tensor pattern for a facial-expression convolutional neural network. Server uses convolutional and fully connected layers trained with a cross-entropy loss function on labeled emotion datasets. Server outputs per-class logits for emotions such as anxiety, calmness, and anger and normalizes them into probabilities.

Server, for voice-based emotion estimation, uses an audio feature extraction library to compute features such as mel-frequency cepstral coefficients, pitch contours, and energy statistics from short audio segments. Server then inputs these features into a recurrent neural network, such as a long short-term memory network, or into a temporal convolutional network trained to predict emotion dimensions such as tension and calmness. Server trains this network using an objective function such as mean squared error between predicted and annotated dimensional emotion scores or cross-entropy for categorical labels. Server stores trained network weights and loads them into memory for inference.

Server, for biological signal analysis, receives heart rate, heart rate variability, and respiration rate as time-series signals. Server applies preprocessing such as detrending and normalization, then segments the signals into windows. Server processes these windows with a time-series model, such as a stacked long short-term memory architecture, to estimate stress and arousal values. The architecture may include input layers, one or more recurrent layers, and a dense output layer with activation functions appropriate for regression (for example, linear activation) or for bounded outputs (for example, sigmoid activation).

Server integrates outputs from the facial-expression model, the voice-based emotion model, and the biological signal model using a multimodal integration model. Server, in one example, employs a neural network architecture that concatenates or otherwise fuses modality-specific embeddings into a joint representation and then passes this representation through fully connected layers to produce an emotional state vector including dimensions such as anxiety level, tension level, and comfort level. Server uses training data that includes simultaneously recorded videos, audio, and physiological measurements annotated with ground-truth emotional states, and learns the integration model by minimizing a multi-task loss function that encourages accurate prediction of each dimension.

Server stores and uses a prompt sentence template that includes placeholders for numerical indicators representing the risk degree and elements of the emotional state vector, as well as placeholders for contextual information such as the type of incident, the surrounding environment situation, and the intended audience. Server also stores parameters indicating desired tone attributes, such as polite versus neutral, and detail-level attributes, such as concise versus detailed. Server fills the placeholders of the prompt sentence template with actual values computed for the current integrated sensor information. By doing so, server programmatically controls the composition of the prompt sentence supplied to the generative AI model.

Server uses a generative AI model, such as a large-scale language model realized by a transformer-type neural network, to generate natural-language outline explanation texts and scripts for audio explanation. Server transmits the constructed prompt sentence as plain text input to the generative AI model, which is hosted either locally on the server hardware or on a separate computation platform communicatively coupled to server. The generative AI model comprises multiple layers of self-attention and feedforward sub-layers and has been pre-trained on large text corpora and optionally fine-tuned on domain-specific explanation data. During training, the generative AI model minimizes a loss function such as cross-entropy between predicted tokens and target tokens, using gradient-based optimization algorithms such as stochastic gradient descent variants and updating model parameters according to backpropagation. During inference in the present system, the generative AI model performs autoregressive token generation conditioned on the prompt sentence, using sampling strategies or beam search to produce coherent output text.

Server, for example, generates a prompt sentence such as:

“You are an assistant that explains the driving policy of an autonomous vehicle to its passenger.

Current risk level: medium, with several vehicles ahead and pedestrians at the upcoming intersection.

Current passenger emotion: anxiety score 0.8, calmness score 0.1.

Current driving policy:
Maximum acceleration is reduced to avoid sudden speed increases.
Maximum deceleration is limited to avoid harsh braking.
The distance to the car in front is kept longer than usual.
Lane changes are minimized and performed only when necessary.

Explain in Japanese, in 2-3 sentences without technical jargon, why this driving policy is safe and reassuring for the passenger, using a calm and polite tone.” Server also generates, in another example, a prompt sentence such as:

“You are an assistant that explains the passenger's feelings in an autonomous vehicle.

Based on the following information, describe in two Japanese sentences how the passenger is likely feeling:
Facial expression: anxiety 0.8, calmness 0.1, anger 0.1
Speech emotion: tension 0.7, calmness 0.3
Biosignals: heart rate 95 bpm, low heart-rate variability, slightly increased breathing rate
Current driving situation: approaching a busy intersection.

Use clear, everyday language that a typical passenger can easily understand.”

Server further generates, when user asks a question, a prompt sentence such as:

“You are an assistant that explains the behavior of an autonomous vehicle to a passenger.

The passenger asked: ‘Why are we driving so slowly?’

Current situation: there are several vehicles ahead and pedestrians in the intersection; acceleration is being limited to avoid sudden movements; the headway distance is kept longer than usual; the passenger is highly anxious.

Please answer in Japanese in 2-3 sentences, without technical jargon, and in a polite and reassuring tone.”

Server sends each such prompt sentence to the generative AI model and receives generated texts. Server can further perform simple post-processing, for example, by checking that the number of sentences falls within a configured range or by verifying that prohibited vocabulary is absent. Server then classifies the generated text as either an outline explanation for related persons, an explanation for observers, or an answer to a user question, and transmits the text to terminal.

Terminal receives outline explanation texts and scripts and performs audio generation processing. Terminal may use a text-to-speech engine, implemented either on terminal or on server, to convert the explanation text into audio waveforms. Terminal then plays the audio to user via speakers integrated into the wearable device or via external speakers. Terminal may also display the explanation text on the display of the wearable device or on a separate display device, thereby providing multi-modal feedback.

User perceives the site outline information and safety evaluations through visual and auditory channels. User can change their attitude or behavior in response, for example by adjusting their route to avoid a hazard or by preparing specific equipment before arriving at the site. User may speak questions or commands in natural language, which terminal captures as audio signals and forwards to server, thereby triggering additional prompt sentence constructions and generative AI responses.

The described architecture provides technical improvements over conventional systems. Server maintains integrated sensor information with synchronized time and position, allowing a single data structure to support both risk computation and emotion computation. Because server performs alignment once, rather than in separate pipelines, computation is more efficient, and latency between sensor capture and explanation output is reduced. In addition, server uses specialized discrimination models and emotion recognition models with specific feature extraction and model architectures, rather than simple rule-based or threshold-based logic. This yields higher accuracy in detecting hazardous events and in recognizing emotional states, directly improving the relevance of generated explanations.

Furthermore, server programmatically constructs prompt sentences from numerical indicators and structured outline information, and supplies them to a generative AI model. This interface enables the generative AI model to exploit internal statistical patterns to produce explanations that are dynamically adapted in content and tone to risk and emotion conditions. This behavior is not a mere automation of human writing but rather an improvement of the computing system itself, by reducing the number of manually coded templates, reducing rule complexity, and enabling a single generative model to serve multiple explanation contexts. Server also controls length, vocabulary, and tone through explicit fields in the prompt sentence template. By grounding these fields in numerical emotion state vectors and risk indicators, server can systematically adapt the generative output to user conditions. This structured control leads to more consistent and predictable outputs and allows the system to achieve a reduction in unnecessary information load, which is a technical effect on the data communication and storage subsystems.

In addition, because terminal performs local preprocessing, such as down-sampling images and compressing audio before transmission, the average data size per integrated sensor information unit is reduced. This reduction lowers bandwidth usage, reduces transmission time, and decreases the probability of congestion or packet loss in the network. The resulting lower latency and improved reliability constitute technical effects that directly benefit real-time situational awareness.

Server, in alternative embodiments, can substitute or augment the specific neural network architectures. For example, server may use a vision transformer for image-based object detection, a conformer-based network for audio emotion analysis, or a graph-based neural network for multimodal integration. Server may also vary the number of layers, hidden units, and attention heads to suit resource constraints or accuracy requirements. Server can train the models using different optimization algorithms, such as adaptive gradient methods, and can apply data augmentation techniques such as random cropping, time stretching, or noise injection to improve generalization. These variations remain within the scope of the claimed system as long as server performs the functions of computing a risk degree, estimating an emotional state, generating prompt sentences including both, and using a generative AI model to produce explanation texts.

Terminal, in other embodiments, can be integrated into different hardware platforms.

Terminal could be implemented as a handheld device, a vehicle-mounted device, or a body-worn device other than glasses, as long as it provides imaging, audio capture, and communication capabilities. Terminal may or may not perform local feature extraction; in some configurations, terminal sends raw or lightly processed data to server, while in other configurations, terminal executes preliminary object detection or emotion estimation using local machine-learning models to further reduce server load.

User, in further embodiments, may be a field responder, a remote operator, or a person located at a control center. The explanations generated by server and delivered by terminal can be tailored to each role by adjusting the prompt sentence template, for example by specifying more technical language for control center staff and more everyday language for on-site observers. In each case, the core mechanism of linking integrated sensor information, risk and emotion estimation, and generative AI-based explanation via structured prompt sentences remains the same and constitutes the core technical contribution of the invention.

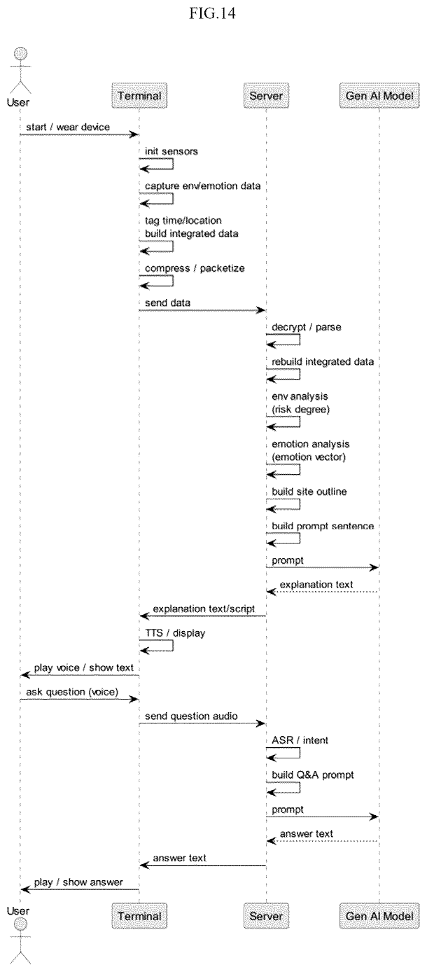

The following describes the processing flow using FIG. 14.

### Step 1:

Terminal initializes sensors and starts data acquisition.

Terminal receives as input a system start event, for example a power-on signal or an application start instruction. Terminal configures an imaging device to capture image frames at a predefined resolution and frame rate, an audio input device to capture audio samples at a predefined sampling rate, and optionally a biological signal sensor to capture physiological signals at a predefined sampling interval. Terminal reads raw pixel data from the imaging device, raw audio samples from the audio input device, and raw biological signal values from the biological signal sensor. Terminal then performs basic formatting operations, such as converting image data into a standard image format, segmenting the audio stream into fixed-length frames, and organizing biological signal values into time-ordered arrays. Terminal outputs formatted sensor streams consisting of time-sequenced images, audio frames, and biological signal records.

### Step 2:

Terminal attaches time and position to sensor streams and constructs integrated sensor information.

Terminal receives as input the formatted sensor streams from Step 1 and time information and position information from a clock module and a positioning module. Terminal assigns a timestamp and a position tag to each image frame, each audio frame, and each biological signal record by combining the sensor data with the corresponding time and position values. Terminal then aggregates the tagged records into a unified integrated sensor information structure, for example as a composite object that holds arrays of records indexed by time. Terminal performs data alignment operations so that sensor records acquired within a common time window share a common index, which facilitates subsequent joint analysis. Terminal outputs integrated sensor information that encapsulates environment information and emotion-related information with synchronized time and position annotations.

### Step 3:

Terminal preprocesses and compresses integrated sensor information for transmission. Terminal receives as input the integrated sensor information from Step 2. Terminal applies resolution reduction to images, for example by down-sampling each frame to a smaller pixel grid, and optionally crops regions that are not needed for analysis. Terminal encodes sequences of image frames into compressed video segments using a video compression algorithm, and compresses audio frames using an audio codec to reduce data size. Terminal applies simple filtering to biological signal records to remove obvious outliers, and converts all records into a structured, serializable format. Terminal then groups compressed video segments, compressed audio segments, and structured biological signal records into a transmission packet or a set of packets, and attaches minimal control headers needed for reassembly. Terminal outputs transmission-ready data blocks that contain compact representations of the integrated sensor information.

### Step 4:

Terminal transmits integrated sensor information to server over a secure channel. Terminal receives as input the transmission-ready data blocks from Step 3. Terminal establishes an encrypted communication session with server using a secure transport protocol, performing a handshake to negotiate encryption parameters. Terminal then sends the data blocks across the network, optionally implementing buffering and retransmission logic in case of temporary communication failures. Terminal monitors acknowledgments from server to confirm successful delivery and may adjust the sending rate based on network conditions. Terminal outputs data packets delivered to server that carry environment information and emotion-related information in compressed, tagged form.

### Step 5:

Server receives and reconstructs integrated sensor information.

Server receives as input encrypted data packets from terminal over the network connection. Server decrypts each packet using the negotiated session keys and verifies integrity checksums to detect transmission errors. Server then parses packet headers to separate compressed video segments, compressed audio segments, and structured biological signal records. Server decodes compressed video segments into sequences of image frames and decodes compressed audio segments into sequences of audio samples. Server reconstructs data structures that match the integrated sensor information format defined at terminal, reattaching the time and position annotations associated with each piece of sensor data. Server outputs reconstructed integrated sensor information ready for analysis.

### Step 6:

Server performs environment perception and computes risk degree.

Server receives as input the reconstructed integrated sensor information from Step 5, focusing on environment information elements such as image sequences and any available motion or location context. Server feeds each image frame into a trained discrimination model, for example a convolutional neural network, to generate outputs that include detected object classes, such as persons and vehicles, and associated bounding box coordinates and confidence scores. Server then processes these detections through a state estimation algorithm, for example by treating each detected object as part of a track and recursively updating an estimated position and velocity for each track. Server calculates predicted future positions for each tracked object and determines a minimum predicted distance and potential intersection events relative to a reference location. Based on these calculations, server computes a numerical risk degree index, for example by aggregating probabilities of hazardous events over all tracked objects. Server converts the numerical risk index into a representation usable by later stages, such as a scalar value or a set of categorical levels. Server outputs a risk descriptor that summarizes object arrangements, predicted movements, and an overall risk degree.

### Step 7:

Server performs emotion estimation and computes an emotional state vector.

Server receives as input the reconstructed integrated sensor information from Step 5, focusing on emotion-related information elements such as audio samples, expression images, and biological signals. Server applies an image processing routine to frames containing a face, cropping and normalizing the face region and inputting it into a facial expression recognition model to obtain emotion probability distributions. Server extracts acoustic features from audio frames and inputs these features into a voice-based emotion recognition model to obtain numerical scores for emotional dimensions such as tension and calmness. Server segments biological signals into time windows and inputs these windows into a time-series model that outputs estimates of physiological stress and arousal levels. Server then passes all modality-specific emotion estimates into a multimodal integration model, which combines them into a single emotional state vector with predefined components, for example anxiety, tension, and comfort. Server outputs this emotional state vector as a compact representation of the observer's emotional state.

### Step 8:

Server constructs site outline information from risk and emotional state.

Server receives as input the risk descriptor from Step 6 and the emotional state vector from Step 7. Server derives structured site outline information by combining objective aspects, such as location, approximate scale of the incident, number of involved entities, and danger level, with subjective aspects, such as suitable detail level and tone determined by the emotional state. Server performs mapping operations that take numerical risk values and emotional scores and produce qualitative labels, for example converting a high risk value and high anxiety score into a recommended cautious tone with enhanced emphasis on safety. Server assembles these attributes into a data structure representing site outline information, which includes descriptive fields and meta-fields for expression style and detail level. Server outputs site outline information that is ready to be expressed in natural language.

### Step 9:

Server generates a prompt sentence for the generative AI model.

Server receives as input the risk descriptor, the emotional state vector, and the site outline information from Step 8. Server retrieves a stored prompt sentence template that contains textual scaffolding and placeholders for risk-related phrases, emotional descriptors, outline content, and desired tone constraints. Server inserts numerical indicators, descriptive terms, and instructions into the template by replacing the placeholders with actual values. For example, server may produce a prompt sentence such as:

“You are an assistant that explains the situation at an incident site to responders.

Current risk level: high, with several vehicles involved and pedestrians nearby.

Observer emotion: anxiety level 0.9, comfort level 0.1.

Site outline: a multi-vehicle collision at a busy intersection, involving approximately ten persons, with potential secondary hazards.

Explain in simple and concise language why caution is required and what general situation responders will encounter, using a calm and reassuring tone.”

Server outputs a complete prompt sentence that encodes both analytical results and constraints for the generative AI model.

### Step 10:

Server calls the generative AI model to generate explanation text.

Server receives as input the prompt sentence from Step 9. Server passes this prompt sentence as a text input to a generative AI model, such as a transformer-based language model, either running locally on server hardware or accessed via a networked service. Server initiates a text generation request specifying configuration parameters, for example a maximum output length and decoding method. The generative AI model processes the prompt sentence and returns a sequence of output tokens that form a natural-language explanation. Server reconstructs these tokens into an explanation text and, if necessary, adjusts minor formatting, such as line breaks and sentence delimiters. Server outputs the generated explanation text, which can serve as an outline explanation for responders or observers.

### Step 11:

Server generates a script for audio explanation and applies content controls.

Server receives as input the explanation text from Step 10 and the site outline information from Step 8. Server formats the explanation text for audio scripting by inserting pauses, adjusting sentence structure for spoken clarity, and annotating emphasis cues if the downstream audio system supports them. Server may perform content checks, using simple rules or classifiers, to ensure the script does not contain undesired terms or overly technical expressions when the emotional state vector indicates high anxiety. Server then outputs the finalized script for audio explanation along with metadata, such as language code and speaking style, to terminal or to an audio synthesis module.

### Step 12:

Terminal generates audio from the script and presents information to user.

Terminal receives as input the script for audio explanation and any associated metadata from server. Terminal passes the script text to a speech synthesis engine, selects a voice profile and speaking rate based on the metadata, and requests generation of an audio signal representing the explanation. Terminal receives synthesized audio data and routes it to audio output hardware, such as headphones or speakers integrated into the wearable device. Terminal may also display the explanation text on a visual interface of the wearable device. Terminal thereby presents the site outline information and safety evaluation to user in synchronized audio and visual form, and outputs perceptible cues that can influence user behavior and decisions.

### Step 13:

User receives explanations and optionally provides additional input.

User receives as input the audio explanation and any visual text presented by terminal in Step 12. User interprets the description of the incident site, assesses the stated risk and safety instructions, and may decide to change actions accordingly, such as altering a route or preparing specific tools before arrival. User may also respond verbally with questions or clarifications, for example asking, “How many people are involved?” or “Is there any fire risk?” Terminal captures this spoken input as new audio data and forwards it to server, which then uses similar steps to construct new prompt sentences and generate further explanations. User thus forms a closed-loop interaction with the system, where explanations are continuously adapted to updated conditions and user feedback.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

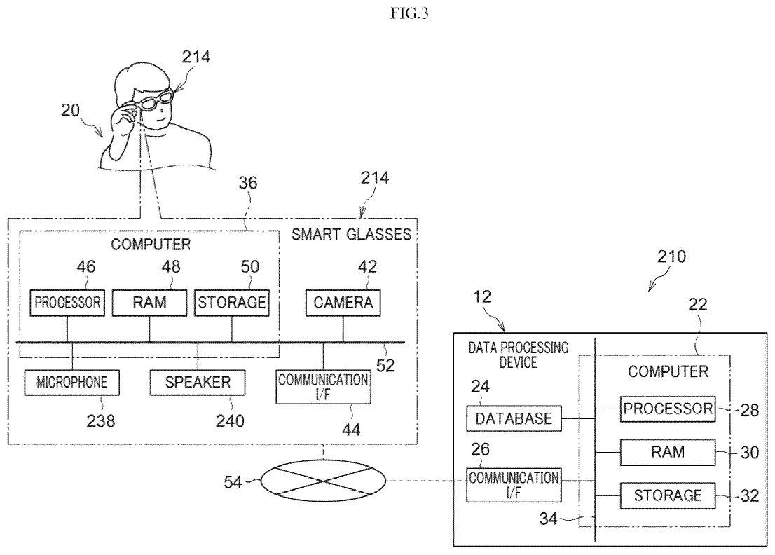

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

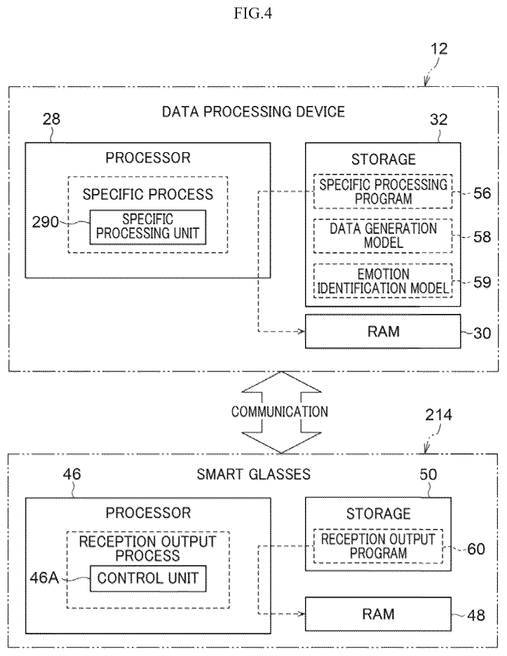

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

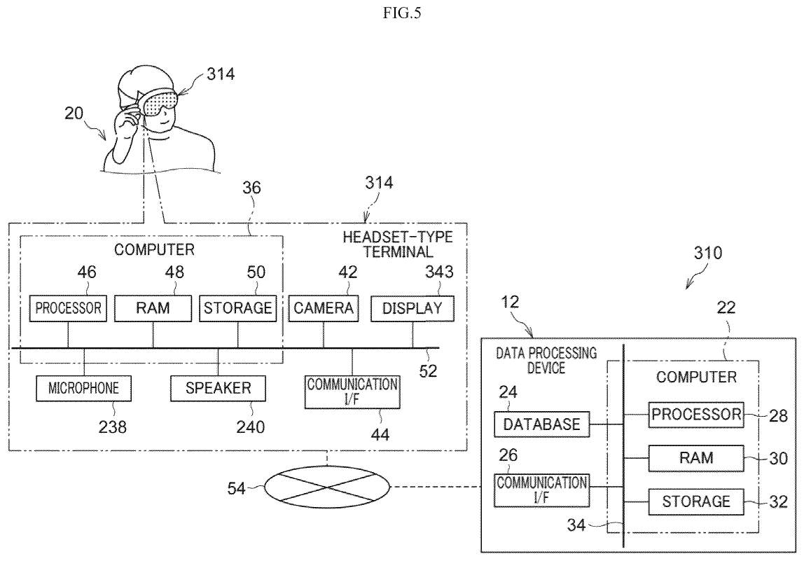

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

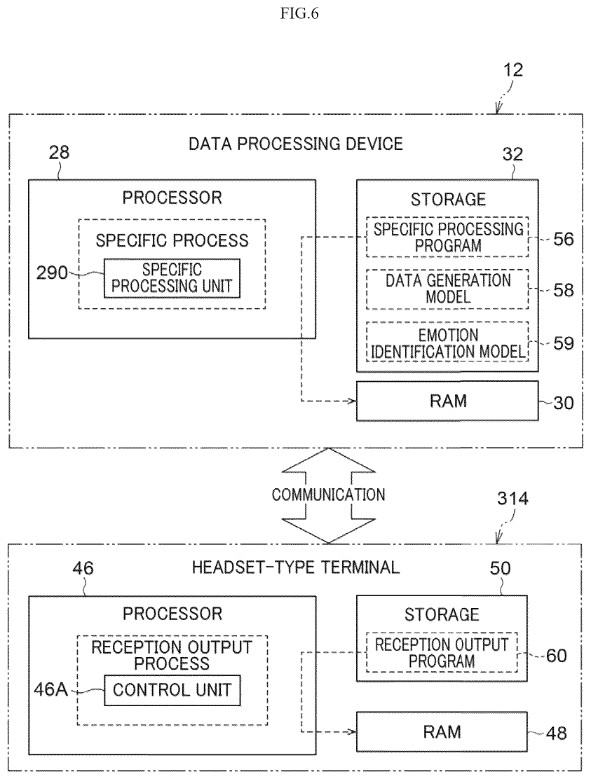

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

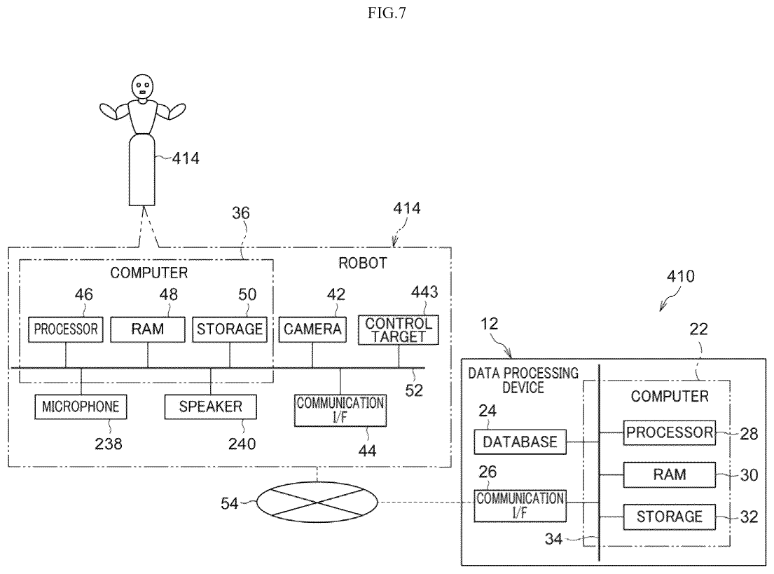

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

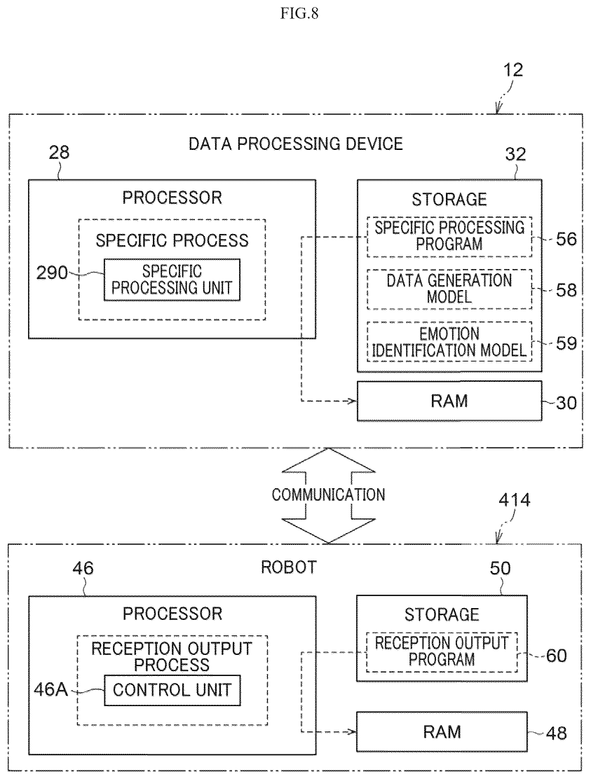

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

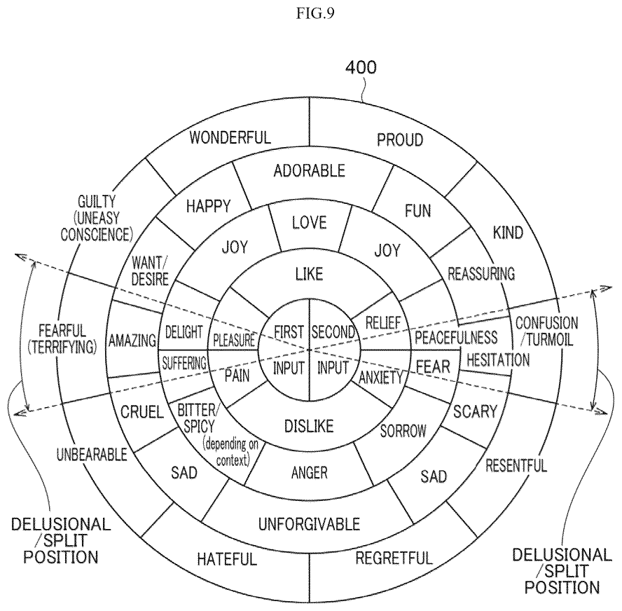

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

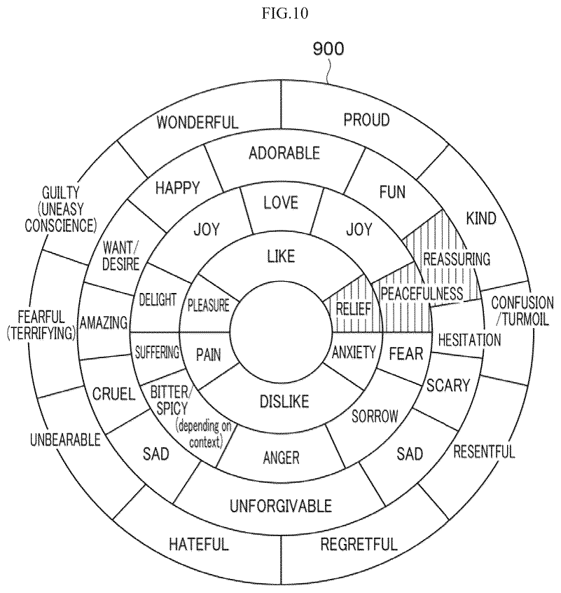

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, from an information processing device worn by a user located near a scene of an accident, incident, or disaster, image information, audio information, position information, and motion information, and to associate the acquired image information, audio information, position information, and motion information with time information to generate an information group,
encrypt the information group and sequentially transmit the encrypted information group to an information processing server via a secure communication path,
cause the information processing server to execute feature extraction processing and object classification processing on the image information stored in a storage device to detect objects including persons, moving bodies, structures, and hazardous factors, and to execute speech recognition processing and language analysis processing on the audio information to extract phrases and acoustic events related to urgency, and to integrate the extracted objects and phrases with the position information and the motion information to generate structured information representing a situation at a site,
generate an input text for a generative information processing model, the input text including a prompt sentence that instructs the generative information processing model to perform situation summarization, danger degree estimation, and response policy generation based on the structured information, and input the input text and the structured information to the generative information processing model to cause the generative information processing model to generate explanation text information including a type of the site, a scale of the site, an obstruction state, and an expected damage content,
generate, on the basis of the explanation text information, first explanation text information for stakeholders and second explanation text information for stakeholders in transit, and convert the second explanation text information into audio information by speech synthesis processing, and
transmit the first explanation text information and the audio information to a communication terminal device and cause the communication terminal device to present the first explanation text information and the audio information in association with map display information and travel route information.

### (Supplementary 2)

The system according to supplementary 1,
wherein the processor is configured to
generate the prompt sentence input to the generative information processing model so as to list, from the structured information, a number, position, movement state, presence or absence of hazardous factors, presence or absence of traffic obstruction, and urgency information of extracted phrases for the detected objects, and to instruct the generative information processing model, through wording included in the prompt sentence, to generate, in a predetermined format, a summary text that explicitly describes a traffic regulation state, a recommended approach route, and required response resources based on a content of the structured information.

### (Supplementary 3)

The system according to supplementary 1,
wherein the processor is configured to
cause the information processing server to generate the structured information and the explanation text information for each update unit, to re-input, for each update unit, the input text including the prompt sentence to the generative information processing model so as to sequentially generate updated summary information corresponding to a change in the situation at the site, and to automatically transmit notification information including the generated updated summary information to the communication terminal device.

### Application Example 1

### (Supplementary 1)

A system comprising a processor,
wherein the processor is configured to
acquire situation data from wearable image acquisition equipment and from a plurality of types of detection equipment mounted on a moving body,
preprocess the situation data and transmit the preprocessed situation data to a processing apparatus by using a secure communication scheme,
recognize, in the processing apparatus, objects and acoustic events existing in a surrounding environment by using machine learning based on the situation data, and predict future behaviors of the objects and collision risks,
generate a text-based prompt sentence on the basis of a recognition result and a risk prediction result, input the prompt sentence into a generative AI model, and obtain a natural-language output relating to situation evaluation and response instructions from the generative AI model, generate, on the basis of the natural-language output, operation control instructions including at least a speed, a route, and a stop position of the moving body, and an outline explanation sentence for related persons,
transmit the operation control instructions to a control apparatus on the moving body so that the operation control instructions are converted into travel control signals, and
provide the outline explanation sentence to related persons heading to a site by at least one of voice synthesis processing and display processing.

### (Supplementary 2)

The system according to supplementary 1,
wherein the processor is configured to
describe the text-based prompt sentence by combining structured information including at least positions, speeds, classifications, predicted trajectories, and risk indices of the objects with a natural-language description, and analyze the natural-language output obtained from the generative AI model and convert the natural-language output into a sequence of control parameters including at least a numerical speed target, a stop distance, and a type of avoidance action.

### (Supplementary 3)

The system according to supplementary 1,
wherein the processor is configured to
record the situation data, the operation control instructions corresponding to the natural-language output of the generative AI model, and an operation history from a user, and update at least one of recognition processing based on the machine learning and generation rules of the text-based prompt sentence by using the recorded data as learning data.

### Example 2

### (Supplementary 1)

A system comprising a processor,
wherein the processor is configured to
acquire, from an information processing device worn or carried by a human located at or near a site of an accident, incident, or disaster, image information, audio information, position information, and posture information by using an imaging function, a sound acquisition function, a position information acquisition function, and a posture information acquisition function of the information processing device, associate the acquired image information, audio information, position information, and posture information with common time information to generate a plurality of types of time-series data, perform predetermined compression processing and encryption processing on the plurality of types of time-series data to generate transmission data, and transmit the transmission data to a server via a communication network;
the processor is further configured to receive the encrypted transmission data from the information processing device, perform decryption processing on the encrypted transmission data, perform decoding processing on image information contained in the decrypted transmission data to generate analysis image information, perform decoding processing on audio information contained in the decrypted transmission data to generate analysis audio information, associate the position information and the posture information with the analysis image information and the analysis audio information to generate an analysis data set, execute image recognition processing on the analysis image information to identify physical objects at the site and movement states of the physical objects, execute speech recognition processing and acoustic analysis processing on the analysis audio information to extract conversation content, important words, and acoustic events, estimate emotional states of humans present at the site based on at least a part of the analysis image information, the analysis audio information, and the posture information, and output information relating to the physical objects, information relating to the acoustic events, and information relating to the emotional states;
and the processor is further configured to calculate a physical hazard level, a subjective tension level, and a psychological tension level based on the information relating to the physical objects, the information relating to the acoustic events, and the information relating to the emotional states output from the analysis data set, calculate a comprehensive hazard index by integrating the physical hazard level, the subjective tension level, and the psychological tension level, generate a prompt sentence by structuring, as a natural language instruction sentence, condition information including the information relating to the physical objects, the information relating to the acoustic events, the information relating to the emotional states, and the comprehensive hazard index, input the prompt sentence into a generative AI model to generate situation report text for organizations involved in response and guidance text for humans present at or near the site, and provide the situation report text and the guidance text to the organizations and the humans via a communication interface and at least one of a display interface and a sound output interface.

### (Supplementary 2)

The system according to supplementary 1,
wherein the processor is configured to
execute facial analysis processing including extracting a face region from the analysis image information and performing expression classification processing on the face region, execute acoustic emotion analysis processing including extracting acoustic features from the analysis audio information and performing voice emotion classification processing on the extracted acoustic features, execute text emotion analysis processing including performing natural language processing on character strings obtained by the speech recognition processing to classify emotions, execute posture analysis processing including calculating an index indicating a physical tension degree based on the posture information, and calculate, based on results of the facial analysis processing, the acoustic emotion analysis processing, the text emotion analysis processing, and the posture analysis processing, an emotion index for each human as a unified emotion indicator, and aggregate emotion indices corresponding to a plurality of humans within a same area to calculate a crowd tension level indicating a psychological state of a crowd.

### (Supplementary 3)

The system according to supplementary 1,
wherein the processor is configured to
generate, based on the comprehensive hazard index and the crowd tension level, a plurality of types of prompt sentences including generation conditions different between the situation report text for the organizations and the guidance text for the humans, instruct the generative AI model, based on a first prompt sentence for the organizations, to generate report text including at least a site position, a physical damage situation, an estimated number of injured persons, a risk of secondary damage, and a required response scale, and instruct the generative AI model, based on a second prompt sentence for the humans, to generate guidance text including reassurance content and recommended actions corresponding to the emotional states of the humans and a safety level of the site, and convert the guidance text into sound data by executing speech synthesis processing and cause the information processing device to present the sound data.

### Application Example 2

### (Supplementary 1)

A system comprising a processor,
wherein the processor is configured to
collect, from a wearable display device located near an incident site, environment information including image information and audio information, and emotion-related information including utterances and movements of a wearer, and to add time information and position information to the environment information and the emotion-related information to store them as integrated sensor information,
analyze the integrated sensor information by applying a trained discrimination model and a state estimation algorithm to the image information, the audio information, and the position information included in the integrated sensor information so as to identify object arrangements, moving object behaviors, and a risk degree indicating a probability of occurrence of a hazardous event at the incident site, and by applying an emotion recognition model to utterance content, acoustic features, expression information, and biological signals included in the integrated sensor information so as to estimate an emotional state of an observer,
define, on a basis of the risk degree and the emotional state, site outline information including information relating to a position, a scale, a number of involved persons, and a danger level of the incident site, the site outline information having an expression style and a level of detail corresponding to the emotional state, generate a prompt sentence including the risk degree, the emotional state, and the site outline information, and input the prompt sentence to a generative information processing model so as to generate a natural-language outline explanation text and a script for audio explanation, and
perform audio generation processing on a basis of the outline explanation text and the script for audio explanation, and provide the site outline information and a safety evaluation of the incident site to related persons heading to the incident site or related persons located remotely.

### (Supplementary 2)

The system according to supplementary 1,
wherein the processor is configured to
hold a prompt sentence template including numerical indicators representing the risk degree and the emotional state, conditions relating to a surrounding environment situation at the incident site, a response policy to be taken, and a tone required for an explanation, and embed the numerical indicators and the site outline information into the prompt sentence template so as to cause the generative information processing model to generate an explanation text for related persons and an explanation text for observers in a distinguished manner.

### (Supplementary 3)

The system according to supplementary 1,
wherein the processor is configured to
integrate, in a time series manner, expression images, audio signals, and biological signals acquired from the wearable display device or from a biological information acquisition device cooperating with the wearable display device, perform image feature extraction processing, acoustic feature extraction processing, and biological signal analysis processing, input results of the processing to a multimodal integration model so as to output an emotional state vector including at least an anxiety level, a tension level, and a comfort level, and dynamically change a length, a presence or absence of technical terms, and a tone of the explanation text in the prompt sentence for the generative information processing model on a basis of the emotional state vector.

What is claimed is:

1. A system comprising:
circuitry configured to:
receive, via a communication interface coupled to a packet-switched network, image data and audio data from a plurality of wearable devices located within a geographic region, the wearable devices each comprising an image sensor, a microphone, and a positioning sensor;
analyze the image data using an object detection neural network to classify detected objects and analyze the audio data using a speech recognition model to extract text data;
generate structured situation data by integrating classification results from the image data, the extracted text data, and position data received from the positioning sensors;
construct a prompt data structure encoding the structured situation data, transmit the prompt data structure to a generative neural network model, and receive summary data from the generative neural network model;
convert at least a portion of the summary data into synthesized audio data using a speech synthesis model; and
transmit the summary data and the synthesized audio data to one or more terminal devices via the communication interface.

2. The system according to claim 1, wherein the circuitry identifies the plurality of wearable devices located within the geographic region based on position data received from the positioning sensors of the wearable devices, and transmits a permission request data packet to each identified wearable device via the communication interface before collecting the image data and the audio data.

3. The system according to claim 2, wherein the circuitry collects the image data and the audio data in real time only from wearable devices from which a permission grant data packet has been received, and encrypts the collected image data and the audio data using an encrypted communication protocol before storing the data in a storage device coupled to the packet-switched network.

4. The system according to claim 3, wherein each wearable device further comprises an inertial measurement unit, and wherein the circuitry receives motion data from the inertial measurement unit and associates the image data, the audio data, the position data, and the motion data with timestamp information to generate time-correlated information groups stored in the storage device.

5. The system according to claim 1, wherein the object detection neural network comprises a convolutional neural network with a plurality of convolutional layers, normalization layers, and classification layers, and outputs for each detected object a bounding box, a class label, and a confidence score.

6. The system according to claim 5, wherein the circuitry further analyzes the image data to detect hazardous condition indicators including at least one of smoke, fire, structural damage, and fluid leakage based on visual pattern classification, and incorporates the detected hazardous condition indicators into the structured situation data.

7. The system according to claim 6, wherein the circuitry analyzes the audio data by extracting acoustic features including mel-frequency cepstral coefficients, performing speech recognition to generate the text data, and performing acoustic event classification to identify non-speech audio events, and incorporates the non-speech audio event classifications into the structured situation data.

8. The system according to claim 1, wherein the prompt data structure includes a structured text sequence encoding at least detected object class labels, detected hazardous condition indicators, extracted text phrases with urgency indicators, position coordinates, and timestamp information.

9. The system according to claim 8, wherein the generative neural network model comprises a transformer-based architecture with a plurality of self-attention layers, and wherein the summary data received from the generative neural network model includes at least a situation type classification, a scale estimate, an obstruction state, and recommended response parameters.

10. The system according to claim 9, wherein the circuitry derives from the summary data a first summary data subset formatted for display on a stationary terminal device and a second summary data subset formatted for audio delivery to a mobile terminal device, and converts the second summary data subset into the synthesized audio data using the speech synthesis model.

11. The system according to claim 1, wherein the circuitry repeatedly receives updated image data and updated audio data from the plurality of wearable devices at periodic intervals, generates updated structured situation data, constructs an updated prompt data structure, and transmits the updated prompt data structure to the generative neural network model to receive updated summary data reflecting changes over time.

12. The system according to claim 11, wherein the circuitry compares the updated summary data with previously generated summary data, identifies changed elements, and transmits only the changed elements as differential update data packets to the one or more terminal devices to reduce transmission bandwidth.

13. The system according to claim 1, wherein the circuitry associates the summary data with map display data by mapping position coordinates from the structured situation data to geographic map tile data stored in the storage device, and transmits the map display data together with the summary data to the one or more terminal devices.

14. The system according to claim 13, wherein the circuitry generates route data from a current position of a terminal device to the geographic region based on the position coordinates and real-time traffic data received via the communication interface, and transmits the route data together with the synthesized audio data to the terminal device.

15. The system according to claim 1, wherein the circuitry is further configured to:
receive, via the communication interface, feedback data from the one or more terminal devices; and
update at least one of the prompt data structure construction and the summary data formatting based on the feedback data.

16. The system according to claim 15, wherein the circuitry estimates a stress state of a recipient based on at least one of interaction timing patterns from the terminal device, voice characteristics extracted from audio input received from the terminal device, and text sentiment extracted from text input received from the terminal device.

17. The system according to claim 16, wherein the circuitry adjusts a level of detail and a delivery format of the summary data based on the estimated stress state, transmitting a concise summary with prioritized action items when the estimated stress state exceeds a threshold and transmitting a detailed breakdown when the estimated stress state is below the threshold.

18. A system comprising:
a communication interface including a network interface controller coupled to a packet-switched network and configured to transmit and receive data packets;
a memory storing instructions, an object detection neural network comprising a plurality of convolutional layers, a speech recognition model, a generative neural network model comprising a transformer architecture with a plurality of self-attention layers, and a speech synthesis model; and
circuitry comprising one or more processors coupled to the memory and configured to execute the instructions to:
receive, via the communication interface, image data, audio data, and position data from a plurality of wearable devices located within a geographic region;
analyze the image data using the object detection neural network to classify detected objects and analyze the audio data using the speech recognition model to extract text data;
generate structured situation data by integrating the classification results, the extracted text data, and the position data with timestamp information;
construct a prompt data structure encoding the structured situation data and transmit the prompt data structure to the generative neural network model to receive summary data including a situation type classification and recommended response parameters;
convert at least a portion of the summary data into synthesized audio data using the speech synthesis model; and
transmit the summary data and the synthesized audio data to one or more terminal devices via the communication interface.

19. The system according to claim 18, wherein the circuitry is further configured to estimate a stress state of a recipient based on interaction data received from the one or more terminal devices, and to adjust a level of detail of the summary data based on the estimated stress state.

20. A method performed by circuitry of a server coupled to a packet-switched network via a communication interface, the method comprising:
receiving, via the communication interface, image data and audio data from a plurality of wearable devices located within a geographic region, the wearable devices each comprising an image sensor, a microphone, and a positioning sensor;
analyzing the image data using an object detection neural network to classify detected objects and analyzing the audio data using a speech recognition model to extract text data;
generating structured situation data by integrating classification results from the image data, the extracted text data, and position data received from the positioning sensors;
constructing a prompt data structure encoding the structured situation data, transmitting the prompt data structure to a generative neural network model, and receiving summary data from the generative neural network model;
converting at least a portion of the summary data into synthesized audio data using a speech synthesis model; and
transmitting the summary data and the synthesized audio data to one or more terminal devices via the communication interface.
